(19) United States
(12) Patent Application Publication
(10) Pub. No.: US 2026/0289518 A1
(43) Pub. Date: Sep. 24, 2026

(54) SYSTEM

(71) Applicant: SoftBank Group Corp., Tokyo (JP)

(72) Inventor: Yuki SHINOTSUKA, Tokyo (JP)

(73) Assignee: SoftBank Group Corp., Tokyo (JP)

(21) Appl. No.: 19/561,859

(22) Filed: Mar. 10, 2026

(30) Foreign Application Priority Data
Mar. 19, 2025 (JP) 2025-044494

(51) Int. Cl. G06Q 10/1093; G06F 40/103; G06F 40/169; G06F 40/205; G06F 40/253; G06F 40/284; G06F 40/295; G06F 40/40; G06N 3/0455; G06N 3/0475; H04L 51/224

(52) U.S. Cl. CPC G06Q 10/1093; G06F 40/103; G06F 40/169; G06F 40/205; G06F 40/253; G06F 40/284; G06F 40/295; G06F 40/40; G06N 3/0455; G06N 3/0475; H04L 51/224

(57) ABSTRACT

A system includes a processor that is configured to input a prompt to a generative artificial intelligence model to instruct the generative artificial intelligence model to perform analysis of input information used when creating a meeting notification, and obtain an analysis result from the generative artificial intelligence model, refer to a predetermined rule set in order to determine a meeting format based on the analysis result, and automatically generate content of the meeting notification based on the determined meeting format and register the generated meeting notification in a schedule management system.

### CROSS-REFERENCE TO RELATED APPLICATION

This application is based on and claims priority under 35 USC 119 from Japanese Patent Application No. 2025-044494 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for creating meeting notifications in calendar or email services require a user to manually determine and input the meeting format, such as in-person or online, and to manually compose and register detailed meeting information. In particular, when the user inputs meeting-related information in natural language, conventional systems are not capable of sufficiently understanding the semantic content, inferring an appropriate meeting format, and automatically generating structured meeting notifications based on that content. As a result, the user is burdened with repetitive operations such as selecting the meeting format, editing text, adjusting the tone or details of the notification, and registering the finalized notification into a schedule management system. Furthermore, conventional systems do not take into account the emotional state of the user when generating the content of the meeting notification, and therefore cannot flexibly adjust the content in a manner that is appropriate to the user's current emotions. Accordingly, there is a need for a system that can effectively utilize a generative artificial intelligence model, natural language processing, and emotion analysis to automatically determine a meeting format and generate and register a suitable meeting notification based on user input information.

### SUMMARY

In order to solve the above-described problems, a system according to one aspect of the invention comprises a processor, wherein the processor is configured to input a prompt to a generative artificial intelligence model to instruct the generative artificial intelligence model to perform analysis of input information used when creating a meeting notification, and obtain an analysis result from the generative artificial intelligence model. The processor is further configured to refer to a predetermined rule set in order to determine a meeting format based on the analysis result, and to automatically generate content of the meeting notification based on the determined meeting format and register the generated meeting notification in a schedule management system. In some embodiments, the processor is configured to apply an emotion analysis algorithm to recognize an emotion of a user, and to adjust the content of the meeting notification in accordance with the recognized emotion. In some embodiments, the processor is configured to analyze the input information by using natural language processing, extract important words from the input information, and determine a related meeting format based on the extracted words. By these means, the system automatically interprets user input, determines an appropriate meeting format, adapts the content to the user's emotional state, and generates and registers a meeting notification with reduced manual effort by the user.

The term “system” refers to an arrangement of one or more hardware devices, software components, or combinations thereof, which cooperatively execute processing related to analysis of input information, determination of a meeting format, and automatic generation and registration of a meeting notification.

The term “processor” refers to one or more processing units, such as a central processing unit (CPU), a graphics processing unit (GPU), a microprocessor, or a combination thereof, configured by hardware, software, or firmware to execute instructions implementing the functions described in the claims.

The term “input information” refers to information entered by a user or otherwise supplied to the system for the purpose of creating a meeting notification, including at least textual information such as a meeting subject, description, agenda, or other free-form natural language content.

The term “prompt” refers to data, including at least a text sequence, that is provided to a generative artificial intelligence model in order to instruct the generative artificial intelligence model to perform analysis or generation related to the input information.

The term “generative artificial intelligence model” refers to a machine learning model, such as a large language model or other generative model, trained on data to generate or analyze text or other content in response to a prompt.

The term “analysis result” refers to information output by the generative artificial intelligence model in response to the prompt, the information including, for example, interpreted meaning, extracted features, semantic categories, or other data derived from the input information.

The term “rule set” refers to a collection of one or more rules defined in advance, each rule specifying a condition and a corresponding action or decision, and used by the processor to determine a meeting format based on the analysis result.

The term “meeting format” refers to a classification or type of meeting, including at least an in-person meeting format, an online meeting format, or other formats that define how the meeting is to be conducted.

The term “meeting notification” refers to data representing a meeting to be registered or shared, including at least a subject, time, participants, and information indicating the meeting format, and used for informing participants or registering an event in a schedule management system.

The term “schedule management system” refers to a calendar system, scheduler, or other application or service that manages events, appointments, or tasks, and that stores and displays the generated meeting notification.

The term “emotion analysis algorithm” refers to a procedure or model executed by the processor to estimate or recognize a user's emotional state based on input data such as text, voice, or other signals.

The term “emotion of a user” refers to an estimated emotional state of the user, such as happiness, anger, sadness, stress, or other affective states, recognized by the emotion analysis algorithm.

The term “natural language processing” refers to a set of techniques and algorithms that enable the processor to analyze, interpret, and process human language text contained in the input information.

The term “important words” refers to words, phrases, or tokens extracted from the input information that are determined, by the natural language processing, to be relevant to identification of the meeting format or to generation of the meeting notification content.

The term “related meeting format” refers to a meeting format that is selected or inferred based on the important words extracted from the input information and the predetermined rule set.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

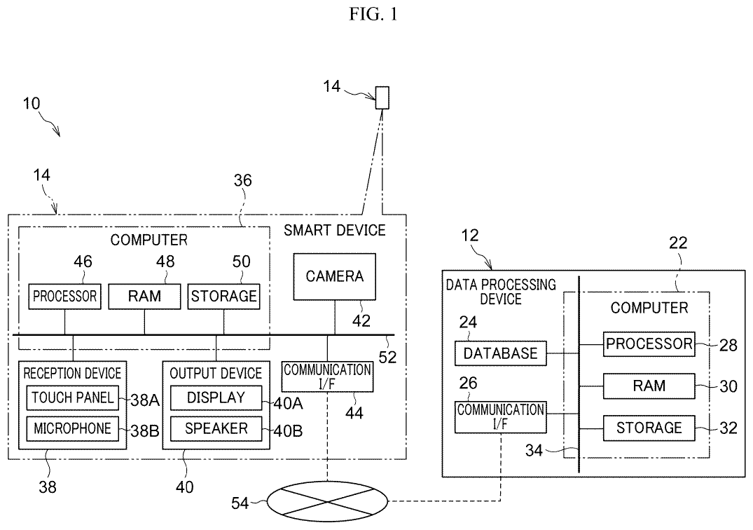

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

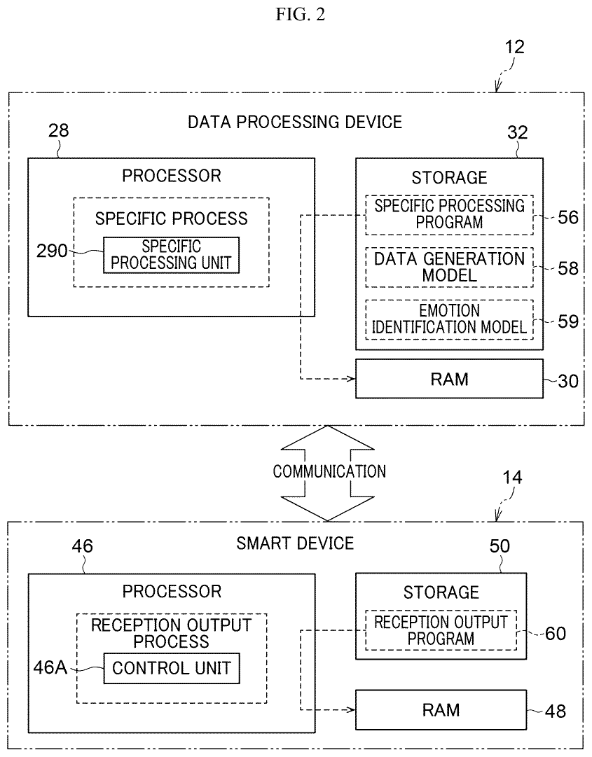

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional electronic scheduling systems require a human user to manually determine a meeting format, such as an online meeting or a face-to-face meeting, when creating a meeting notification. In many implementations, the server simply stores literal user input, and does not perform robust interpretation of natural language expressions contained in a meeting subject or body. As a result, the server cannot reliably infer whether an online conference service should be invoked, what kind of meeting identifier or physical location should be generated, or how the notification text should be adapted to the context of the request. This leads to frequent manual configuration steps, redundant user operations, and inconsistent meeting setup, particularly in large-scale environments where many meetings are created by different users with diverse wording styles.

Furthermore, existing systems that incorporate natural language processing often rely either solely on fixed keyword rules or solely on a generative artificial intelligence model. A purely rule-based approach is brittle and fails to recognize variations in wording, while a purely model-based approach can produce inconsistent or opaque results that are difficult to integrate into deterministic business logic. In addition, many systems do not treat the interaction with a generative AI model as a configurable component of the overall scheduling pipeline, and thus do not exploit prompt sentence design in combination with local rule sets to improve reliability and transparency of the meeting-format decision.

Conventional servers also typically do not optimize internal processing resources for this kind of automated interpretation. For example, storage, natural language processing, and emotion analysis resources are not orchestrated as a coherent pipeline that turns raw input into structured meeting format information and meeting setting information. As a consequence, the server cannot systematically generate online meeting identifiers, physical locations, or notification texts that reflect both the inferred meeting format and the emotional tone of the user's request. This limits the ability of the computing system to improve the quality and efficiency of meeting management at the infrastructure level, and forces users to compensate for system shortcomings through manual edits.

Accordingly, there is a need for an improved computer-implemented technique in which a server coordinates storage resources, natural language processing resources, rule sets, and generative AI models via prompt sentences, so that the server can automatically infer a meeting format from natural language input, generate appropriate meeting setting information, and register and distribute a meeting notification with reduced user burden and increased processing reliability.

The specific processing by the specific processing unit 290 of the data processing device 12 in Example 1 is realized by the following means.

The present invention provides a server comprising a processor configured to acquire input information for creating a meeting notification and store the input information in a storage resource, preprocess character information included in the input information and input the preprocessed character information to a natural language processing resource to extract phrases and specify candidate meeting formats including an online meeting and a face-to-face meeting, generate a prompt sentence including instruction content for causing a generative information processing model to perform determination of a meeting format based on the input information and input the prompt sentence to the generative information processing model to obtain an analysis result including a meeting format or supplementary information relating to the meeting format, determine the meeting format on the basis of the candidate meeting formats specified from the phrases and the analysis result and generate meeting setting information including an online meeting identifier for an online meeting or physical location information for a face-to-face meeting in accordance with the determined meeting format, and automatically generate content of the meeting notification on the basis of the determined meeting format, the meeting setting information, and schedule date-time information and participant information included in the input information, register the meeting notification as schedule information in an information management service having a schedule management function, and transmit notification information to participants on the basis of the schedule information. This enables a computer-implemented scheduling infrastructure to automatically interpret natural language meeting requests, to coordinate rule-based and generative AI-based analysis for robust meeting format determination, and to generate and distribute meeting notifications with appropriate online meeting identifiers or physical locations while reducing user operations and improving the overall reliability and efficiency of meeting management processing.

The term “processor” refers to a hardware or virtual information processing unit, such as a central processing unit or an execution core of a computing device, that executes instructions to perform operations defined by a program.

The term “storage resource” refers to a hardware or software component, such as a memory device or a database system, that is configured to store and retrieve data including input information, intermediate results, and meeting notifications.

The term “input information” refers to data provided by a user or an external system for creating a meeting notification, including at least a meeting subject, schedule date-time information, and participant information.

The term “character information” refers to text data represented as a sequence of characters, such as a meeting subject line or description sentence included in the input information.

The term “preprocess” refers to performing one or more normalization or preparation operations on character information, such as converting to a standard character case, removing extraneous symbols, or segmenting the text into tokens, prior to further analysis.

The term “natural language processing resource” refers to a software-implemented information processing module that processes human language text, including functions such as morphological analysis, part-of-speech classification, and rule-based phrase extraction.

The term “phrase” refers to a unit of text obtained from character information, such as a token, word, or multi-word expression, that can be used to infer semantic meaning relevant to meeting format determination.

The term “candidate meeting format” refers to a possible classification of how a meeting is to be conducted, including at least an online meeting format and a face-to-face meeting format, that is tentatively specified prior to final determination.

The term “online meeting” refers to a meeting that is conducted via a communication network using an online conferencing service, and that is joined by participants through an electronic meeting link or access identifier.

The term “face-to-face meeting” refers to a meeting in which participants gather at the same physical location and interact in person, rather than via an online conferencing service.

The term “prompt sentence” refers to a sequence of characters or text content that includes instruction information and contextual information, which is input to a generative information processing model to cause the model to output an analysis result related to a meeting format.

The term “generative information processing model” refers to a machine-implemented model, such as an artificial intelligence model trained on text data, that generates an output including natural language text or structured information in response to a prompt sentence.

The term “analysis result” refers to information output from the generative information processing model in response to a prompt sentence, the information including at least a meeting format or supplementary information relating to the meeting format.

The term “meeting format” refers to a classification that indicates a mode of conducting a meeting, including at least an online meeting mode and a face-to-face meeting mode.

The term “meeting setting information” refers to information used to configure execution of a meeting according to a determined meeting format, including at least an online meeting identifier or physical location information.

The term “online meeting identifier” refers to data used to identify or access an online meeting in an online conferencing service, such as a meeting URL, meeting code, or access token.

The term “physical location information” refers to data that specifies a real-world place at which a face-to-face meeting is held, such as a room designation, building name, or address.

The term “meeting notification” refers to information that notifies one or more participants of details of a meeting, including at least a meeting format, schedule date-time information, and participant information, and optionally meeting setting information.

The term “schedule date-time information” refers to data indicating a scheduled time for a meeting, including at least a start time and optionally an end time or duration.

The term “participant information” refers to data identifying participants of a meeting, such as communication identifiers including electronic mail addresses or account identifiers.

The term “information management service” refers to a software-implemented service that manages user information including schedule information, and that provides at least a schedule management function.

The term “schedule management function” refers to a function of creating, storing, updating, or displaying schedule information, such as calendar entries or planned events.

The term “schedule information” refers to structured data representing an event in a schedule management function, including at least schedule date-time information and associated meeting notification content.

The term “notification information” refers to data transmitted from the server to participants to inform them of a meeting, the data including at least part of the meeting notification content.

The term “emotion analysis processing resource” refers to a software-implemented module that analyzes character information to estimate an emotional state, such as positive, negative, or neutral sentiment, associated with the text.

The term “emotional state” refers to an estimated condition of emotion derived from emotion analysis, such as a sentiment category or an affective score, which reflects how a user is presumed to feel.

The term “text body” refers to a portion of the meeting notification that is presented as a main textual message, such as the main description or body of an electronic mail.

The term “representation style” refers to a manner of expressing text in a meeting notification, such as formality level, politeness, or tone, which can be adjusted according to an emotional state.

The term “morphological analysis processing” refers to processing that segments character information into morphemes and determines grammatical attributes of each segment.

The term “part-of-speech classification processing” refers to processing that assigns a grammatical category, such as noun, verb, or adjective, to elements of character information.

The term “rule-based phrase extraction processing” refers to processing that extracts phrases from character information according to predetermined rules, such as pattern matching rules or classification rules.

The term “rule set” refers to a collection of rules that define correspondence between extracted phrases and a meeting format or other categories, and that is referenced by the processor to perform determination.

The term “important word” refers to a phrase or token extracted from character information that is treated as having high relevance to the determination of the meeting format.

The term “online meeting service” refers to a communication service provided via a network that enables multiple participants to join an online meeting session, typically using an application or web interface.

In one embodiment, a server cooperates with one or more terminals used by users to implement the claimed meeting-notification system. The server includes a processor, a main memory, a non-volatile storage device, and a network interface. The terminal includes a display, an input device, a local processor, and a communication module. The server executes an operating system, such as a general-purpose server operating system, and runs application software including a web application framework, a natural language processing library, and a generative AI client module. The terminal executes a web browser or a native application that presents a scheduling user interface to the user.

The user operates the terminal to access an electronic communication service that provides a schedule management function. The terminal displays a calendar screen and an input screen for creating a meeting notification, including fields for a meeting subject, schedule date-time information, and participant information. The terminal converts the user's input into structured data, for example as a data object with fields corresponding to the subject, start time, end time, and participant identifiers, and transmits this data to the server via a network using a protocol such as HTTPS.

The server receives the input information through the network interface and stores the input information in a storage resource, such as a relational database management system executing on the non-volatile storage device. The server represents each meeting request as a record having fields including a textual subject field, schedule date-time fields, and one or more participant identifier fields. The server assigns a unique identifier to each record and maintains indexing structures on date-time fields and subject fields to enable efficient retrieval and further processing.

The server preprocesses character information included in the input information before performing any higher-level analysis. The server uses a natural language processing resource implemented by a library such as a statistical or neural text processing toolkit executing in the main memory. The server converts the subject text to a normalized representation by applying operations such as lowercasing, Unicode normalization, whitespace normalization, and removal of extraneous punctuation according to predetermined rules. The server then segments the normalized text into tokens by applying a tokenization algorithm that separates words and punctuation based on character categories and language-specific rules.

The server applies morphological analysis processing and part-of-speech classification processing to the tokenized text. The server, for example, uses a sequence labeling model trained on annotated text to assign each token a part-of-speech tag and, optionally, a lemma.

The server uses a model such as a bidirectional recurrent neural network, a transformer-based encoder, or a conditional random field stacked on top of word embeddings and subword embeddings. The server stores the resulting tokens, tags, and lemmas in an in-memory data structure, such as a list of token objects, each object containing attributes including the token string, lemma, part-of-speech tag, and character offsets.

The server executes rule-based phrase extraction processing on the annotated tokens. The server holds a rule set in memory, the rule set including pattern definitions that describe sequences of token attributes. For example, one rule matches any token whose lemma corresponds to a known online meeting service name; another rule matches adjectives or compound nouns that indicate a face-to-face context. The server compares the annotated token sequence against these patterns, and, when a pattern matches, the server extracts the corresponding phrase and labels it as a candidate indicator of a meeting format. The server aggregates extracted phrases into a list of candidate meeting format indicators and stores this list as part of the processing context for the meeting record.

The server constructs candidate meeting formats from the extracted phrases. The server maps each extracted phrase to one or more meeting format candidates according to the rule set. For instance, a phrase matching an online meeting service name is mapped to an online meeting candidate, while a phrase including a “face-to-face” expression is mapped to a face-to-face meeting candidate. The server computes a confidence value for each candidate by aggregating contributions from matched rules. By representing the candidates and their confidence values in a structured form, such as a vector or a dictionary keyed by meeting format type, the server enables subsequent processing modules to combine these rule-based inferences with outputs of a generative AI model in a deterministic and reproducible way.

The server generates a prompt sentence to obtain an additional analysis result from a generative AI model. The server composes the prompt sentence as a natural language instruction that includes both explicit instructions and embedded input information. The server can use, for example, the following prompt sentence:

“Please determine the meeting format based on the following subject line. If the text clearly describes an online meeting (for example, mentions an online conferencing service name or the word ‘online’), respond exactly with ‘ONLINE’. If the text clearly describes a face-to-face meeting (for example, mentions ‘face-to-face’ or ‘in-person’), respond exactly with ‘IN_PERSON’. If you cannot clearly determine the format, respond exactly with ‘UNKNOWN’. Subject: ‘Next Tuesday Zoom meeting for project X.’”

The server transmits the prompt sentence to a generative AI model endpoint through the network interface. The generative AI model, in one embodiment, is a large-scale neural language model hosted on a separate computing system, such as a multi-layer transformer architecture with self-attention layers, feedforward layers, and layer normalization, trained on a corpus of natural language text by minimizing a next-token prediction loss or a masked language modeling loss. The server communicates with the generative AI model via an application programming interface, passing the prompt sentence as text and receiving a corresponding output text that encodes the model's classification of the meeting format.

The server parses the output text from the generative AI model and converts the output text into a normalized label. The server, for example, trims whitespace and compares the output string to allowed labels “ONLINE”, “IN_PERSON”, and “UNKNOWN”. The server then incorporates the AI-derived label into the candidate meeting format data structure. By treating the AI output as an additional feature rather than an opaque final decision, the server can combine the generative AI model's generalization capability with the predictability of local rule-based processing.

The server determines the meeting format by combining the candidate formats derived from the extracted phrases with the normalized label derived from the generative AI model. The server applies a decision algorithm that evaluates the confidence values from the rule-based extraction and the classification label or probability inferred from the generative AI output.

The server may maintain a decision table or a small decision model that specifies, for example, that a strong rule-based signal for an online meeting can override an “UNKNOWN” AI response, while consistent signals from both sources produce a final meeting format with a high internal confidence. By executing this decision algorithm, the server converts unstructured textual input and model outputs into a single discrete meeting format value.

The server generates meeting setting information in accordance with the determined meeting format. If the determined meeting format is an online meeting, the server calls an external conferencing service via a conferencing service API over the network. The server sends a request containing structured parameters, such as the scheduled start time, expected duration, and describing user account identifiers, and receives in response a meeting identifier, an access URL, and optional access credentials. The server stores this online meeting identifier and associated metadata in the storage resource linked to the original meeting record.

If the determined meeting format is a face-to-face meeting, the server retrieves physical location information from a configuration data structure stored in the storage resource. The server may retrieve a default meeting room for a given user, department, or resource availability. The server then links the selected location string or location identifier to the meeting record as the physical location information. In some embodiments, the server can also query a room management subsystem to ensure that the selected room is available at the scheduled time, which further constrains and optimizes actual resource usage in the physical environment.

The server automatically generates content of the meeting notification based on the determined meeting format, the meeting setting information, and the schedule date-time information and participant information. The server composes a notification text by inserting the schedule date-time information, online meeting identifier or physical location information, and meeting subject into a template stored in the storage resource. In another embodiment, the server constructs a second prompt sentence and sends the second prompt sentence to the generative AI model to obtain a refined or more natural invitation text. An example of such a prompt sentence is:

“Draft a concise and polite meeting invitation message for the following meeting. Subject: ‘Next Tuesday Zoom meeting for project X.’ Meeting format: ONLINE. Meeting link: [URL]. Participants: [list of participants]. The invitation should clearly state the time, the online nature of the meeting, and how to join.”

The server receives the AI-generated text, applies length limits, filtering of inappropriate expressions according to predetermined rules, and merges the resulting text with mandatory fields such as the meeting link or physical location. The server writes the final notification body into the storage resource as part of the schedule information to be transmitted. The server registers the meeting notification as schedule information in an information management service having a schedule management function. The server interfaces with a calendar service or a schedule management subsystem via an application programming interface, sending a structured representation of the meeting, including the meeting format, schedule date-time information, participant information, and meeting setting information. The server records the identifier returned by the calendar service and associates this identifier with the meeting record. By managing event identifiers and synchronization status in the storage resource, the server maintains consistent state across internal data representations and external calendar systems.

The server transmits notification information to participants based on the schedule information. The server, for example, sends electronic mail messages by communicating with an email transfer subsystem, attaching a calendar file that encodes the meeting details, or by invoking messaging service APIs to deliver direct messages or channel notifications. The server includes in these notifications the online meeting identifier or physical location information, so that participants can join the meeting through their terminals at the scheduled time. The server logs transmission results and failure codes in the storage resource, enabling monitoring and error analysis.

In another embodiment, the server applies emotion analysis processing to an expression included in the input information acquired from the user. The server uses an emotion analysis processing resource, such as a neural classification model that maps sentences to sentiment or emotion classes. The model may be implemented as a transformer-based encoder whose output is fed to a linear classifier trained using a cross-entropy loss to distinguish among emotional categories such as positive, negative, or neutral. The server feeds the preprocessed subject or a portion of the user's free-text entry to this classifier and obtains a probability distribution over emotional categories. The server then adjusts the text body or representation style of the meeting notification according to the estimated emotional state. For example, the server may select a more formal template when the emotion analysis indicates a serious or negative tone, or a more casual template when the emotion analysis indicates a positive tone, thereby changing sentence endings and politeness markers in the generated text.

The server's use of this combination of rule-based extraction, generative AI model interaction via prompt sentences, and structured decision logic yields specific technical effects in the computing environment. Because the server represents extracted phrases, candidate formats, and AI outputs as explicit data structures, the server can avoid repeated full re-analysis of the same input, thereby reducing processor load and network calls to the generative AI service.

Because the server uses indexed storage of meeting requests and precomputed features, subsequent updates or corrections can be processed by referencing only the affected records, which improves data management efficiency and reduces response time. Because the server offloads parts of the linguistic interpretation to a generative AI model while still constraining the model by explicit rules and labels, the server achieves higher classification accuracy than either a simple keyword matcher or an unconstrained text generator, which reduces the rate of incorrect meeting format determinations.

The server thereby improves operation of the underlying computer system. Specifically, the server reduces the number of network transactions to third-party conferencing services by invoking those services only when an online format is confidently determined. This reduces communication load and latency. The server also reduces storage redundancy by generating and storing online meeting identifiers and physical locations in a normalized schema that supports indexing and de-duplication. The combination of neural feature extraction and rule-based interpretation allows the server to classify diverse user expressions with fewer misclassifications, resulting in fewer corrective operations by the user and thereby improving effective throughput of the scheduling infrastructure.

In yet another embodiment, the server executes the generative AI model locally instead of using a remote endpoint. The server loads a trained neural network model from the storage resource into main memory and performs inference on a graphics processing unit or dedicated accelerator. The model may be a multi-layer transformer with a fixed number of attention heads per layer, trained by minimizing a loss function that combines a language modeling objective with a classification objective for meeting format labels. The server executes a forward pass through this model for each prompt sentence, computes token-wise probabilities, and extracts a classification output token or probability vector corresponding to the meeting format. The server can adjust model parameters by fine-tuning on domain-specific text data, using gradient-based optimization and weight updates controlled by an optimizer such as an adaptive moment estimation algorithm. By hosting the model locally, the server further reduces latency and dependency on external services, and can control batch sizes and quantization schemes to optimize inference throughput and memory usage.

The terminal, in all embodiments, functions primarily as an input and display endpoint. The terminal receives schedule information and meeting notifications from the server and renders them on the display. The terminal may show an icon or label indicating whether a meeting is online or face-to-face, and may present a selectable link to join an online meeting. The user can inspect, modify, or cancel meetings through the terminal's interface. When the user submits changes, the terminal sends updated input information to the server, which triggers re-execution of the analysis and decision processes. Because the heavy text analysis and model inference are performed on the server, the terminal can remain lightweight, and many terminals can share the same centralized intelligent scheduling infrastructure. Through these embodiments, the server, the terminal, and the user cooperate to implement the claimed system. The server does not merely automate a human's mental determination of meeting format; instead, the server uses specific data structures, hybrid AI-and-rule algorithms, and optimized storage and communication patterns to improve the technical functioning of the scheduling system itself, achieving increased processing speed, improved classification accuracy, reduced communication load, and more consistent management of meeting-related data in a computer network environment.

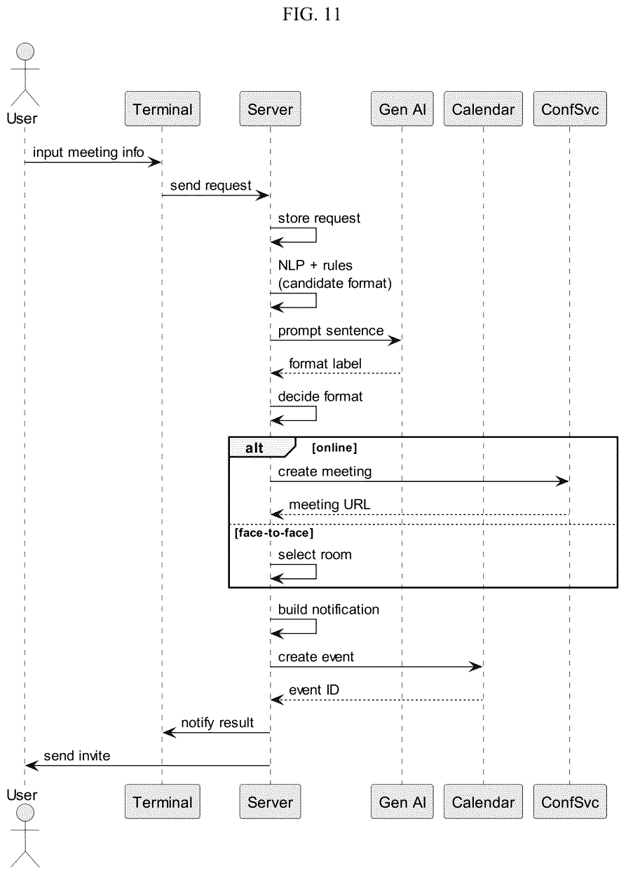

The following describes the processing flow using FIG. 11.

### Step 1:

The user operates the terminal to open a scheduling screen of an electronic communication service. The terminal displays input fields for a meeting subject, schedule date-time information, and participant information. The user inputs a subject such as “Next Tuesday Zoom meeting for project X,” selects a date and time, and specifies participant identifiers such as email addresses. The input to this step is user keystrokes and selection operations on the terminal UI, and the output is structured input information held temporarily in the terminal's memory, for example a data object containing the subject string, a start-time value, an optional end-time value, and a list of participant identifiers.

### Step 2:

The terminal validates the structured input information and sends it to the server. The terminal checks that the schedule date-time information conforms to a valid format and that participant identifiers follow a syntactic pattern, such as an email address pattern. The terminal then converts the in-memory data object into a serialized message, such as a JSON or form-encoded payload, and transmits the payload to the server over a network connection using a protocol such as HTTPS. The input to this step is the structured input information produced in Step 1, and the output is a network message that contains the validated input information in a machine-readable format delivered to the server.

### Step 3:

The server receives the network message from the terminal and stores the input information in a storage resource. The server parses the serialized payload to reconstruct the subject string, the schedule date-time information, and the participant identifier list. The server assigns a unique internal identifier to the meeting request and writes a new record into a database table, including fields for the raw subject, schedule times, participants, and an initial status value such as “PENDING_ANALYSIS.” The input to this step is the network message from the terminal, and the output is a persistent meeting request record stored in the database, indexed by the internal identifier.

### Step 4:

The server preprocesses character information contained in the subject field of the meeting request. The server retrieves the subject string from the database, converts it to lowercase, applies Unicode normalization, and removes or standardizes punctuation according to predefined rules. The server then segments the normalized string into tokens by scanning character sequences and splitting at whitespace and punctuation boundaries. The input to this step is the raw subject string from the meeting record, and the output is a tokenized and normalized representation of the subject, such as a list of token objects each containing a token string and character position information.

### Step 5:

The server performs natural language analysis on the tokenized subject using a natural language processing resource. The server feeds the token sequence into a morphological analysis module and a part-of-speech classification module, which may be implemented as a trained sequence model. The module computes, for each token, probabilities for available part-of-speech tags and selects the most likely tag, possibly also assigning a lemma form. The server attaches these tags and lemmas to the corresponding token objects. The input to this step is the list of tokens produced in Step 4, and the output is an annotated token sequence in which each token carries morphological and syntactic attributes used for further decision-making.

### Step 6:

The server executes rule-based phrase extraction using the annotated token sequence. The server loads a rule set that encodes patterns indicating terms associated with online meetings, face-to-face meetings, and equivalent expressions. The server scans the annotated token sequence to detect subsequences that match these patterns, for example a token whose lemma matches a known online conferencing service name or a consecutive token pattern representing “face-to-face.” When a match is found, the server extracts the corresponding phrase, labels the phrase with a candidate meeting format type, and optionally assigns a confidence score based on rule priority. The input to this step is the annotated token sequence from Step 5, and the output is a collection of extracted phrases and associated candidate meeting format indicators, stored in an in-memory structure linked to the meeting request identifier.

### Step 7:

The server constructs candidate meeting formats from the extracted phrases and prepares feature data for subsequent combination with a generative AI model output. The server aggregates all candidate indicators of an online meeting into a single online meeting candidate, and aggregates all candidate indicators of a face-to-face meeting into a face-to-face candidate. The server computes a composite confidence value for each candidate by combining the confidence scores of the underlying phrases using a defined aggregation function, such as a weighted sum or maximum. The input to this step is the collection of extracted phrases and rule-based indicators from Step 6, and the output is a structured candidate format representation, for example a data object holding possible formats (online, face-to-face) and their respective confidence values.

### Step 8:

The server generates a prompt sentence for a generative AI model to obtain an additional analysis result. The server constructs a text string that includes instructions and embeds the original subject text. For example, the server generates the following prompt sentence: “Please determine the meeting format based on the following subject line. If the text clearly describes an online meeting (for example, mentions an online conferencing service name or the word ‘online’), respond exactly with ‘ONLINE’. If the text clearly describes a face-to-face meeting (for example, mentions ‘face-to-face’ or ‘in-person’), respond exactly with ‘IN_PERSON’. If you cannot clearly determine the format, respond exactly with ‘UNKNOWN’. Subject: ‘Next Tuesday Zoom meeting for project X.’” The input to this step is the original or normalized subject text and predefined instruction templates, and the output is a complete prompt sentence string ready to be sent to the generative AI model.

### Step 9:

The server sends the prompt sentence to a generative AI model and obtains an analysis result.

The server transmits the prompt text to a model endpoint via a network interface, including necessary authentication parameters. The generative AI model, implemented for example as a transformer-based neural network running on an external or internal system, processes the prompt and returns a text response such as “ONLINE.” The server receives the response, trims whitespace, and normalizes the output to a canonical label. The input to this step is the prompt sentence from Step 8, and the output is a normalized AI-derived meeting format label, such as a string value “ONLINE,” “IN_PERSON,” or “UNKNOWN,” stored as part of the meeting request context.

### Step 10:

The server determines a final meeting format by combining the candidate meeting formats from the rule-based processing and the normalized label from the generative AI model. The server applies a decision algorithm that takes as input the candidate format confidence values and the AI label and produces a single final classification. For example, if the AI label is “ONLINE” and the rule-based confidence for an online meeting exceeds a lower threshold, the server chooses an online meeting as the final format; if the AI label is “UNKNOWN,” the server may choose the candidate with the highest rule-based confidence. The server records the determined meeting format in the database by updating the meeting record's format field and status. The input to this step is the candidate format representation from Step 7 and the AI label from Step 9, and the output is a finalized meeting format designation stored persistently for the corresponding meeting request.

### Step 11:

The server generates meeting setting information according to the determined meeting format. If the format is online, the server creates or retrieves an online meeting identifier by calling an online conferencing service API. The server constructs a request containing the meeting title, schedule date-time, and host account identifier, sends the request over the network, and receives an access URL and meeting code in response. If the format is face-to-face, the server queries a configuration table or a room management system to select an available physical location. The input to this step is the finalized meeting format and the schedule date-time information stored in the meeting record, and the output is meeting setting information, including either an online meeting identifier or a physical location string, stored in association with the meeting record.

### Step 12:

The server constructs the content of the meeting notification based on the determined meeting format, meeting setting information, and the original input information. The server merges the subject, schedule date-time, participant list, and meeting link or location into a notification template, resulting in a structured notification object with a title, body text, and metadata fields. In some cases, the server generates a secondary prompt sentence that describes the meeting details and instructs the generative AI model to draft a polite and concise invitation message, then replaces or augments the body text with the AI-generated message after applying filtering rules. The input to this step is the meeting record containing the format, setting information, and user-provided fields, and the output is a complete meeting notification object ready for registration and transmission.

### Step 13:

The server registers the meeting notification in an information management service having a schedule management function. The server communicates with a calendar or scheduling API, sending the notification object as a structured request to create a new event. The calendar service returns an event identifier and confirmation of creation, which the server stores in the meeting record. The input to this step is the meeting notification object from Step 12, and the output is a created calendar event in the external schedule management system and an updated meeting record containing the external event identifier and a status such as “REGISTERED.”

### Step 14:

The server transmits notification information to participants based on the registered schedule information. The server composes electronic messages for each participant, embedding the meeting subject, schedule date-time information, and online meeting identifier or physical location. The server sends these messages via an email subsystem or a messaging service API and records the success or failure of each transmission. The input to this step is the schedule information that now includes the external event identifier and meeting settings, and the output is delivered notifications on participant terminals and logged transmission results in the server's storage resource.

### Step 15:

The terminal receives and displays the meeting information to the user. The terminal obtains schedule updates from the server or from the external calendar service and refreshes the calendar view to include the newly created event. The terminal shows a visual indicator of the meeting format, such as an icon for an online meeting, and provides the online meeting link or physical location in the event details screen. The input to this step is the schedule information or notification data delivered from the server, and the output is a rendered user interface on the terminal that informs the user and allows the user to join or manage the meeting.

### Step 16:

The user reviews and, if necessary, modifies the meeting details through the terminal. The user can change the subject, time, or other attributes and submit the changes. The terminal converts these modifications into updated input information and transmits the updated information to the server. The server treats the updated information as new input, re-executes the analysis and determination steps as needed, and updates the meeting record and external calendar entry. The input to this step is the existing meeting information as displayed to the user, and the output is revised input information entering the same processing flow, ensuring that subsequent meeting notifications and settings remain consistent with the user's intent.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented scheduling and notification systems typically rely on rigid, template-based logic that merely maps structured input fields to pre-defined notification messages. Such systems require users to enter work schedule information in strictly formatted fields, and backend components simply concatenate strings according to fixed rules. As a result, the underlying computer technology does not flexibly handle natural language input, and cannot adapt notification content to different contexts or user states without substantial manual programming effort.

In particular, when users enter duty information such as shift work in natural language (for example, free-text phrases describing “morning shift”, “afternoon shift”, or “night shift”), conventional systems lack an efficient mechanism for accurately parsing and classifying such free-text input at scale. Back-end processors usually implement ad hoc keyword matching or simple pattern recognition, which degrades in accuracy as the variety of expressions and languages increases. This leads to frequent misclassification of work schedule types and incorrect or incomplete working time notifications. From a computer technology standpoint, the natural language pipeline is not integrated into the core scheduling logic in a way that leverages advanced models while maintaining deterministic control over system behavior. Furthermore, existing systems typically generate notification messages through static templates that are manually authored and hard-coded into the application. These templates do not leverage generative models, and thus cannot efficiently produce diverse and contextually appropriate notifications without exponential template proliferation. Even when external language models are used, their integration is often limited to a single-stage text generation, without a structured, multi-stage prompt design that uses intermediate structured data. This undermines the reliability, controllability, and repeatability of the overall computer-implemented workflow.

In addition, conventional systems do not systematically use intermediate structured representations derived from natural language analysis as parameters in prompt sentences sent to a generative AI model. Without such structured intermediates, the generative model is required to infer all semantics from ambiguous free-form text, increasing computational overhead and error rates. There is no standardized mechanism in conventional architectures for separating (i) deterministic extraction and classification of shift types and time periods using rule information from (ii) stochastic generation of notification text by a generative AI model. This lack of separation makes it difficult to reliably improve both accuracy and efficiency of the computer system as a whole.

Moreover, current systems generally do not incorporate emotion analysis of either user input or model output into the pipeline for generating work schedule notifications. The absence of an integrated emotion analysis step prevents the system from programmatically adjusting writing style, politeness level, or information density of notifications. Consequently, the computer system cannot dynamically tailor message content to different user states, which limits usability and can result in user dissatisfaction, particularly in environments where work shifts are frequently changed and notifications must be sent repeatedly.

Accordingly, there is a need for improved computer-implemented technology that: (i) acquires natural language duty information from user-operated terminals, (ii) performs analysis of the input using natural language processing and rule-based shift classification, (iii) generates structured data representing shift formats and working time periods, (iv) uses such structured data as parameters in prompt sentences for a generative AI model, and (v) registers and delivers working time notifications that are both semantically accurate and stylistically adapted to user states. By organizing the processing into these stages, and by explicitly defining how prompts and structured data are constructed and consumed within the computing system, the invention seeks to improve the functioning of the computer itself in terms of robustness, scalability, and flexibility of natural language-based scheduling and notification operations.

The specific processing by the specific processing unit 290 of the data processing device 12 in Application Example 1 is realized by the following means.

The present invention provides a server comprising at least one processor and at least one memory storing instructions that, when executed by the at least one processor, cause the server to acquire input information including work schedule information as duty information from an information terminal operated by a user and to receive the input information via electronic communication; to perform an analysis process on the received input information based on natural language processing by inputting a prompt sentence to a generative AI model so as to instruct the generative AI model to execute the analysis process, and to obtain an analysis result corresponding to the input information from the generative AI model; to identify, based on the analysis result, a type of the work schedule information as a shift format for the duty information included in the work schedule information, and to specify a work time period corresponding to the shift format with reference to rule information stored in a storage device; to generate structured data including information relating to the specified shift format and the work time period, and to input a prompt sentence including the structured data to the generative AI model so as to cause the generative AI model to generate, as a notification message for the duty information, a natural language sentence of a working time notification; to optionally apply an emotion analysis algorithm to at least one of the analysis result and the input information so as to recognize a user emotion state and to adjust at least one of a writing style, a politeness expression, and an information amount of the working time notification according to the user emotion state; and to register the generated working time notification as notification information in schedule management information and to transmit the notification information to the information terminal to be displayed on the information terminal. This enables the computer-implemented scheduling and notification system to transform unstructured natural language duty information into a structured representation, to leverage the structured representation as parameters in prompt sentences for controlled invocation of a generative AI model, and to generate and deliver working time notifications with improved accuracy, adaptability, and robustness, thereby improving the functioning of the underlying computer technology for shift management and notification generation.

The term “system” refers to an aggregation of hardware components and software components that cooperate to execute the claimed processing, including at least one server device, at least one information terminal, and communication paths between them.

The term “processor” refers to one or more hardware processing units, such as a central processing unit or other execution circuitry, configured to execute instructions stored in a memory to perform the claimed functions.

The term “memory” refers to one or more non-transitory computer-readable storage media, such as semiconductor memory, magnetic storage, or optical storage, that store instructions and data for execution and use by the processor.

The term “server” refers to a computing apparatus including the processor and the memory, configured to provide scheduling, analysis, and notification services to one or more information terminals over an electronic communication network.

The term “information terminal” refers to a user-operated computing apparatus, such as a portable terminal, a stationary terminal, or a browser-based client device, capable of sending input information to the server and receiving and displaying notification information from the server.

The term “input information” refers to data transmitted from the information terminal to the server, including at least text data expressing work schedule information as duty information, and optionally including user identification information, time information, and additional context.

The term “work schedule information” refers to information indicating planned execution of work by a user, including at least a duty category, a time period of the work, and optionally a date, a location, and an assignment.

The term “duty information” refers to a portion of the work schedule information indicating that a user is scheduled to perform a particular work duty, such as a shift, within a specified time period.

The term “shift format” refers to a classification category for the duty information that identifies a type of shift, such as a morning shift, an afternoon shift, or a night shift, and is used to associate the duty information with a corresponding work time period.

The term “work time period” refers to a time interval, including at least a start time and an end time, associated with the shift format, and representing a time span during which the user is scheduled to perform the duty.

The term “electronic communication” refers to transmission and reception of digital data between the information terminal and the server via an electronic communication network, such as a packet-switched network.

The term “natural language processing” refers to a set of computational techniques for analyzing text expressed in a natural language, including at least morphological analysis, tokenization, phrase extraction, and phrase structure analysis.

The term “generative AI model” refers to a trained machine learning model, such as a generative language model, configured to generate text data in response to input data including a prompt sentence and parameters.

The term “prompt sentence” refers to text and associated parameters supplied as input to the generative AI model, the text and parameters instructing the generative AI model regarding a task to perform or content to generate.

The term “analysis result” refers to structured or semi-structured data produced by an analysis process, including at least information indicating a classification of the work schedule information or extracted features such as time expressions and work category expressions.

The term “rule information” refers to stored data defining associations between conditions and outputs, including at least mappings between extracted expressions and shift formats, and mappings between shift formats and work time periods.

The term “storage device” refers to a hardware component for storing rule information, structured data, and other data, such as a database system, a file system, or other data storage apparatus.

The term “structured data” refers to data organized according to a predefined schema, including fields representing at least a shift format, a work time period, and related attributes such as a user identifier and a date.

The term “notification message” refers to text data intended to inform the user of duty-related information, including at least a description of a scheduled duty and its associated work time period.

The term “working time notification” refers to a notification message generated by the system that explicitly informs the user of a scheduled work time period corresponding to a shift format.

The term “notification information” refers to data representing the working time notification in a form suitable for storage and transmission, including at least a message body, a title, a target user identifier, and metadata such as a timestamp.

The term “schedule management information” refers to data stored by the server representing planned events, including at least work schedule information, duty information, and notification information, and used for managing and displaying user schedules.

The term “emotion analysis algorithm” refers to a computational procedure for estimating an emotion state from text or other data, including at least classification of text into predefined emotion categories or levels.

The term “user emotion state” refers to an estimated emotional condition of the user, such as satisfaction, dissatisfaction, stress, or neutrality, derived from the emotion analysis algorithm based on the input information or the analysis result.

The term “writing style” refers to linguistic characteristics of a notification message, including at least sentence length, formality level, and phrasing choices, which can be adjusted in response to the user emotion state.

The term “politeness expression” refers to linguistic elements indicating a degree of politeness or respect in a notification message, such as honorific forms or courteous wording, which can be adjusted by the system.

The term “information amount” refers to a degree of detail included in a notification message, including how many facts, explanations, or instructions are provided in the message.

The term “morphological analysis” refers to a process of segmenting text into morphemes or tokens and assigning grammatical attributes to each token.

The term “phrase extraction” refers to a process of identifying and extracting meaningful sequences of tokens, such as time expressions, duration expressions, and work classification expressions, from text.

The term “phrase structure analysis” refers to a process of determining syntactic relationships among tokens and phrases, thereby obtaining a structural representation of a sentence.

The term “time expression words” refers to words or phrases in text that indicate specific times or periods, such as expressions corresponding to morning, afternoon, evening, or specific clock times.

The term “duration expression words” refers to words or phrases indicating a length of time, such as expressions corresponding to hours, spans, or intervals.

The term “work classification words” refers to words or phrases indicating categories of work or duties, such as expressions corresponding to shifts, roles, or task categories.

In one embodiment, a server executes a program stored in a memory to implement the claimed system. The server includes at least one general-purpose processor, such as a multi-core central processing unit, and optionally one or more graphical processing units for accelerating neural network inference. The server runs an operating system such as a Unix-like operating system and executes an application stack comprising a web server component, an application server component, and a database management component. The server communicates with at least one terminal via an electronic communication network, such as a packet-switched network, using secure communication protocols.

The terminal is a computing apparatus such as a handheld communication device, a tablet computer, or a personal computer. The terminal executes an application or a browser-based client and provides a graphical user interface that enables a user to input duty information in a natural language. The terminal transmits the input information to the server using a communication library implementing Hypertext Transfer Protocol Secure or a similar protocol. The terminal receives notification information from the server and displays working time notifications to the user using a display device controlled by an operating system of the terminal.

The user operates the terminal and inputs work schedule information as free-text duty information, for example by typing phrases in a natural language such as “morning shift”, “afternoon shift”, or “night shift” in a text field. The user may additionally input date information, location information, or comments in corresponding input fields. The terminal converts the input into structured request data and sends the request data to the server.

The server receives the input information and stores the input information and associated metadata, such as a user identifier and a reception timestamp, in a relational database system.

The server uses a data schema in which a table stores raw text input, a table stores analysis results, and a table stores notification records. Each table row includes a primary key and foreign key relationships to maintain referential integrity. The server thereby maintains a persistent and queryable representation of the state of duty-related communications.

The server applies natural language processing to the input information. In one implementation, the server executes a natural language processing library to perform morphological analysis, tokenization, phrase extraction, and phrase structure analysis on the input text. The server converts the text into a sequence of tokens, each token containing a surface form, a part-of-speech tag, and a lemma. The server identifies candidate time expression words, duration expression words, and work classification words based on part-of-speech tags and lexical dictionaries stored in the storage device. The server constructs an intermediate representation such as a feature vector for each sentence, in which dimensions indicate the presence or absence of specific phrases, the relative position of time expressions, and the syntactic relationship between time expressions and work classification words.

The server uses rule information stored in the storage device to determine a shift format and a work time period based on the extracted features. The server stores the rule information as a set of mapping entries that associate combinations of extracted expressions and context conditions with a shift format and a default time interval. For example, the rule information may include entries mapping a phrase corresponding to “morning” to a shift format representing a morning shift and a time interval from 09:00 to 13:00, and entries mapping a phrase corresponding to “night” to a shift format representing a night shift and a time interval from 22:00 to 06:00 on the next day. The server applies these rules to the intermediate representation to deterministically infer a shift format and base time interval. This deterministic rule-based classification avoids requiring the generative AI model to infer core schedule semantics, thereby improving reproducibility and reducing computational complexity.

The server generates structured data representing the determined shift format and the associated work time period. The server encodes this structured data as a record containing fields such as user identifier, shift format code, shift label in a natural language, start time, end time, date, and optional location. The server uses this structured data as the basis for constructing a prompt sentence for a generative AI model. By explicitly separating extraction and classification of shift semantics from text generation, the server reduces ambiguity in the input to the generative AI model and constrains the generative space.

The server employs a generative AI model implemented as a trained neural network, such as a transformer-based language model. The server stores model parameters in a model storage subsystem and loads the parameters into memory for inference. The generative AI model includes multiple attention layers, each comprising self-attention sub-layers and feedforward sub-layers with activation functions such as rectified linear units or related functions. The generative AI model has been pre-trained on a large corpus of text data to predict next tokens and fine-tuned on domain-specific notification data to generate short and polite notifications. The model parameters are optimized during training using an error function such as cross-entropy loss between predicted token distributions and target token distributions, and weight updates are performed by an optimization algorithm such as stochastic gradient descent with momentum or an adaptive method. During fine-tuning, the server or an associated training system may perform data augmentation by paraphrasing existing notifications, varying time expressions, and inserting controlled noise into the training inputs to improve robustness.

The server constructs a prompt sentence that instructs the generative AI model to generate a notification message based on the structured data. For example, the server may construct a prompt sentence as follows:

“You are a system that generates concise Japanese notification messages for employee shifts. Input data:
User name: [user name]
Shift label: morning shift
Start time: 09:00
End time: 13:00

Task: Generate a polite Japanese notification for the user that clearly states that their next shift is a morning shift from 9:00 to 13:00.”

In another example, the server may construct a prompt sentence:
“Generate a Japanese notification message for an employee.
The employee's name is [user name].
The shift type is a night shift.
The working time is from 22:00 to 6:00 the next morning.

The message should explain that this is an overnight night shift and remain concise and polite.”

The server embeds the structured data into fixed positions within the prompt sentence. The server also sets inference parameters for the generative AI model, such as a temperature parameter controlling randomness, a maximum token length, and a penalty parameter controlling repetition. By constraining these parameters, the server ensures that the generated notifications are short, deterministic within a range, and compliant with predetermined style guidelines.

The server inputs the prompt sentence and any additional model parameters into the generative AI model. The server receives from the generative AI model a token sequence representing a natural language notification message. The server decodes the token sequence into a text string using a tokenizer consistent with the training of the generative AI model.

The server may perform post-processing such as removal of extraneous whitespace or replacement of special tokens.

The server optionally applies an emotion analysis algorithm to at least one of the input information and the analysis result. In one implementation, the server uses a separate classifier model, which may also be based on a neural network architecture, to estimate a user emotion state such as neutral, stressed, or dissatisfied. The server constructs features from the input text, such as frequency of exclamation marks, presence of certain sentiment-bearing words, and length of the text, and feeds these features to the classifier model. The classifier outputs a probability distribution over emotion categories, and the server selects the category with the highest probability as the user emotion state. The server then adjusts the writing style, politeness expression, and information amount of the notification by modifying parts of the prompt sentence or by selecting among multiple generated variants. For example, if the user emotion state is estimated as stressed, the server may instruct the generative AI model to generate a more reassuring tone by adding to the prompt sentence: “Use a considerate and supportive tone.”

The server generates the final working time notification by combining the generated text and metadata, such as the shift format code, date, and time interval. The server registers the notification information in the schedule management information stored in the database. The server assigns an identifier to the notification and associates the notification with the corresponding user and duty record. The server transmits the notification information to the terminal through a push notification service or a similar mechanism. The server may also maintain a queue of pending notifications, and a dispatcher module may batch and send notifications to reduce communication overhead and balance network load.

The terminal receives the working time notification and displays the notification to the user in a notification area or within an application interface. The terminal may present the notification as a message such as: “Your next shift is a morning shift from 9:00 to 13:00.” The terminal may also provide an interface for the user to acknowledge or confirm the shift. The terminal transmits the confirmation to the server, and the server updates the corresponding records in the database, enabling consistent state across the system.

The server achieves technical effects beyond mere automation of human tasks. Because the server employs a two-stage process in which deterministic natural language processing and rule-based classification generate structured data before invoking the generative AI model, the server reduces the search space of the generative model and improves the reliability and accuracy of the generated notifications. The server thereby reduces errors related to misinterpreted time expressions and shift types. The structured data representation also enables the server to index and search notifications efficiently, which improves data management and retrieval performance.

The server improves computational efficiency by offloading only constrained tasks to the generative AI model. The server uses rule-based processing and lightweight natural language processing to handle operations that do not require generative capabilities, thus reducing the number of tokens processed by the generative AI model and lowering inference latency and resource usage. The server can parallelize multiple analysis requests by using batch processing and shared model instances, which leads to processing speed improvement for large numbers of users.

The server enhances communication efficiency by generating compact yet informative messages tailored to user emotion states and context. By incorporating emotion analysis into the pipeline, the server avoids redundant or overly verbose notifications and reduces the number of follow-up interactions required for clarification. This reduction in unnecessary communication reduces network traffic and server load.

The server improves robustness compared to conventional systems that either rely solely on static templates or delegate all semantic interpretation to a generative model. The combination of rule-based shift determination, structured data construction, and controlled prompt sentence design reduces variability in model outputs and provides traceable intermediate results. The server logs structured data, prompt sentences, and generated outputs, enabling systematic analysis and refinement of rules and prompts. This traceability supports iterative optimization of system performance.

The server implements unique processing rules that differ from conventional human procedures. For example, the server may apply a rule that, when input text contains overlapping time expressions and work classification words, assigns priority based on learned frequencies or error statistics stored in the rule information. The server may also enforce non-intuitive normalization rules, such as rounding start times to the nearest shift boundary when the input time is within a specific tolerance window. These rules are systematically applied by machine processing and are difficult for human operators to maintain consistently at scale.

The server can be implemented in multiple alternative embodiments. In one embodiment, the server uses a local generative AI model executed on the same hardware as the application server. In another embodiment, the server accesses an external generative AI service via an application programming interface, while still controlling prompt sentence construction and post-processing locally. In another embodiment, the server uses different neural network architectures, such as encoder-decoder models or recurrent neural networks, for the generative AI model, while maintaining the same structured data and prompt-based control interface.

The server can also vary the natural language processing component. In one embodiment, the server uses a dependency parser to obtain explicit dependency trees and uses these trees to more accurately associate time expressions with work classification words. In another embodiment, the server uses a sequence labeling model, such as a bidirectional recurrent neural network with a conditional random field layer, to tag spans corresponding to duty information and time expressions. In each case, the server still produces structured data of shift format and work time period and uses the structured data as input parameters for the generative AI model.

The terminal can also vary in form. In one embodiment, the terminal is a dedicated application running on a handheld device, and in another embodiment, the terminal is a web browser running on a general-purpose computer. In each case, the terminal provides an interface to input natural language duty information and to display generated notifications.

The interface may include autocomplete suggestions derived from recent shift entries, which can further reduce user input errors and improve overall system accuracy.

The user ultimately benefits from timely and accurate working time notifications. The detailed hardware and software interactions among the server, the terminal, the natural language processing component, the rule-based classification module, and the generative AI model collectively realize a computer-implemented system that improves processing speed, accuracy, data management, and communication efficiency compared to conventional template-based notification systems, and that provides a concrete technological advancement in the field of computer-implemented scheduling and notification generation.

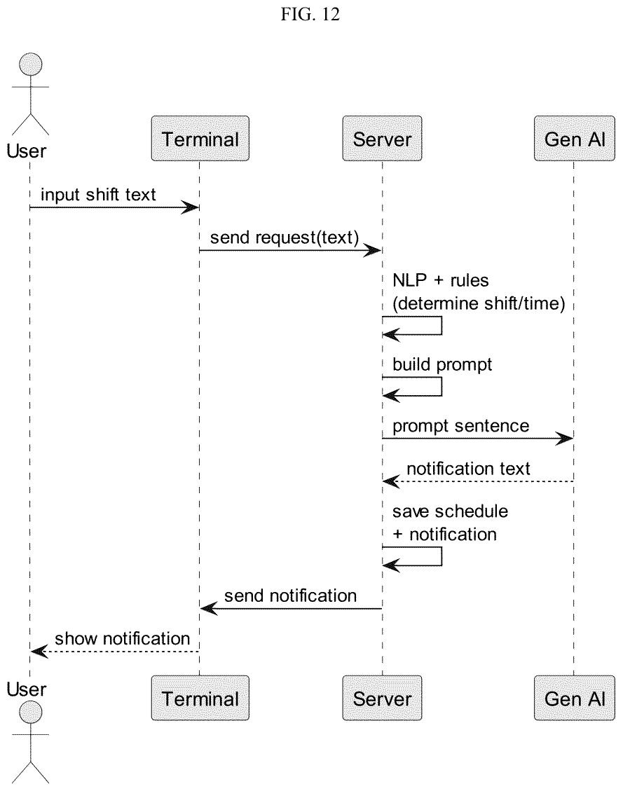

The following describes the processing flow using FIG. 12.

### Step 1:

The user operates the terminal and inputs duty information as text into an input field of a shift management screen. The input includes at least free-text work schedule information, for example “morning shift”, “afternoon shift”, or “night shift”, and may include date or location.

The input of this step is unstructured natural language text typed or selected by the user, and the output is an in-memory representation of the text within the terminal's application. The terminal stores the text in a local data structure, such as a string variable, and validates that the text is not empty and does not exceed a preset length.

### Step 2:

The terminal converts the validated duty information into request data and prepares it for transmission to the server. The input of this step is the locally stored text string and user-related metadata such as a user identifier and a device identifier. The terminal performs data processing including character encoding normalization and construction of a structured message with fields for user identifier, text content, and timestamp. The output is a structured request message that encapsulates the duty information and metadata.

### Step 3:

The terminal transmits the structured request message to the server via an electronic communication network. The input of this step is the structured request message generated in the previous step. The terminal uses a communication stack, such as a Hypertext Transfer Protocol Secure stack, to encapsulate the message in a network packet and to send the packet to a predefined server endpoint. The output is a delivered network request that can be received and decoded by the server.

### Step 4:

The server receives the network request and extracts the input information from the communication payload. The input of this step is the network-level request comprising headers, body, and connection metadata. The server uses a web server and an application server to parse the request, authenticate the user if necessary, and decode the structured message into a server-side data structure. The output is an internal representation of the input information, including the duty text, user identifier, and timestamp, stored in volatile memory on the server.

### Step 5:

The server stores the raw input information and associated metadata in a persistent storage device. The input of this step is the internal representation of the duty text and user-related data. The server performs data processing including assignment of a unique input identifier, formatting the data according to a predefined database schema, and executing write operations to a relational database. The output is a persistent record in a raw input table, which can be retrieved later for analysis, auditing, or error correction.

### Step 6:

The server performs natural language preprocessing on the duty text to obtain linguistic features. The input of this step is the duty text retrieved from memory or storage. The server uses a natural language processing library or equivalent algorithms to perform tokenization, morphological analysis, and phrase extraction, generating tokens annotated with part-of-speech tags and lemmas. The output is an intermediate feature structure that contains a sequence of tokens, identified time expression words, duration expression words, and work classification words.

### Step 7:

The server applies rule information to the extracted linguistic features to determine a shift format and a work time period. The input of this step is the intermediate feature structure and the rule information stored in the storage device. The server performs data processing by matching extracted expressions against rule entries, evaluating priority conditions, and resolving conflicts between overlapping expressions. The output is a shift classification result that includes at least a shift format code and a base time interval with start and end times.

### Step 8:

The server constructs structured data representing the determined duty semantics. The input of this step is the shift classification result and contextual data such as date, user identifier, and optional location. The server generates a structured record containing fields for shift format, shift label, start time, end time, user identifier, and other related attributes. The output is a structured data object that serves as a compact and machine-readable representation of the duty information.

### Step 9:

The server prepares a prompt sentence for a generative AI model using the structured data. The input of this step is the structured data object generated in the previous step. The server performs string composition and parameter insertion to embed values such as shift label, start time, end time, and user name into a text template. The output is a prompt sentence that explicitly instructs the generative AI model how to generate a working time notification. For example, the server may output a prompt sentence such as:

“You are a system that generates concise Japanese notification messages for employee shifts.

Input data:
User name: [user name]
Shift label: morning shift
Start time: 09:00
End time: 13:00

Task: Generate a polite Japanese notification for the user that clearly states that their next shift is a morning shift from 9:00 to 13:00.”

### Step 10:

The server invokes the generative AI model to generate a notification message based on the prompt sentence. The input of this step is the prompt sentence and, optionally, model parameters such as temperature and maximum output length. The server submits the prompt sentence to a generative AI model implemented as a neural network and receives a sequence of output tokens representing the generated text. The output is a natural language notification message, for example: “Your next shift is a morning shift from 9:00 to 13:00.”

### Step 11:

The server optionally performs emotion analysis and adjusts the notification content. The input of this step is at least one of the generated notification message, the original duty text, and the analysis result from the natural language preprocessing step. The server uses an emotion analysis algorithm or model to estimate a user emotion state and then modifies components of the notification, such as tone or level of detail, by regenerating parts of the message or by altering the prompt sentence and re-invoking the generative AI model. The output is an adjusted notification message that takes into account the estimated user emotion state.

### Step 12:

The server constructs a notification record and registers it in schedule management information. The input of this step is the final notification message and the structured data representing the duty semantics. The server performs data aggregation, combining text, shift format code, time interval, and user identifier into a single notification record. The server writes this record into a notification table and links it to schedule management records, enabling subsequent retrieval and display. The output is a stored notification entry associated with the relevant work schedule.

### Step 13:

The server transmits the notification information to the terminal. The input of this step is the stored notification entry retrieved from the notification table. The server formats the information into a delivery payload that includes at least a message title, the notification message body, and identifiers for tracking. The server sends the payload via a push notification service or a direct communication channel to the terminal. The output is a delivered notification payload available to the terminal's operating system or application.

### Step 14:

The terminal receives the notification payload and renders the working time notification to the user. The input of this step is the notification payload delivered over the network. The terminal's communication module decodes the payload and passes the content to the user interface component, which displays the title and message body in a notification area or dedicated application screen. The output is a visually presented notification that the user can read.

### Step 15:

The user reviews the displayed working time notification and optionally performs a confirmation operation. The input of this step is the notification displayed on the terminal screen. The user evaluates the content and interacts with the terminal, for example by tapping a confirmation button or opening a detailed view. The output is user interaction data indicating that the notification has been acknowledged or that additional information has been requested.

### Step 16:

The terminal transmits the user interaction data back to the server, and the server updates internal records accordingly. The input of this step is the interaction data, including user identifier, notification identifier, and interaction type. The server processes the data by recording the confirmation status or request for changes in the schedule management information. The output is an updated database state reflecting user acknowledgment or subsequent actions related to the duty information.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional meeting notification systems largely rely on fixed templates, manual configuration of meeting parameters, and simplistic rule-based parsing of user input. When a user inputs free-form natural language, existing systems typically cannot reliably interpret the user's intent, distinguish between face-to-face and online formats, or derive constraints such as time windows, locations, and participant conditions without substantial manual intervention. As a result, the user is forced to translate natural-language requirements into rigid forms, separately consult calendar and room-reservation systems, and manually configure online meeting services, which leads to increased operational burden and a high risk of errors and inconsistencies.

Further, many known systems treat a generative AI model merely as a text generator, without integrating its structured analysis capabilities into the core scheduling logic. They do not use the model to produce machine-interpretable results that directly control branching between face-to-face and online flows, nor do they systematically link model outputs to downstream data-access operations, such as querying reservation data stores or invoking external online meeting services. This lack of tight integration prevents effective automation and creates latency and reliability issues, because the model output often must be manually or heuristically reinterpreted.

Moreover, prior systems generally do not adapt the content and tone of meeting notifications to the user's emotional state, and thus fail to exploit emotion-aware processing to improve clarity and user acceptance. They also do not employ a unified processing pipeline that takes a single prompt sentence, performs model-based analysis, rule-based determination, resource lookup, external service invocation, and notification text optimization as one coherent computer-implemented workflow. Consequently, the technical infrastructure for generating meeting notifications remains fragmented, inefficient, and prone to inconsistent outputs, and does not fully utilize modern natural language processing and generative AI capabilities to improve the functioning of the computer system itself.

Accordingly, there is a need for a computer-implemented technology that (i) uses a generative AI model as an analysis engine for prompt sentences, (ii) converts the analysis result into structured control information for meeting-format determination via a rule set, (iii) automatically orchestrates access to internal reservation data and external online meeting services, and (iv) programmatically generates and refines meeting notification texts, optionally considering emotion analysis, thereby improving the efficiency, reliability, and adaptability of the meeting notification generation process executed by the server.

The specific processing by the specific processing unit 290 of the data processing device 12 in Example 2 is realized by the following means.

The present invention provides a server comprising a processor configured to receive input information including a prompt sentence from a user terminal, to transmit the input information as an analysis request to a generative AI model, and to obtain an analysis result from the generative AI model; to reference a predetermined rule set based on meeting-related attribute information extracted from the analysis result so as to determine whether a meeting is to be conducted in a face-to-face format or in an online format as a meeting format; to, when the meeting format is determined to be the face-to-face format, execute an inquiry process to an information storage device storing reservation information of meeting places and schedule information of participants, extract available meeting places and time slots, and generate face-to-face meeting notification information including the available meeting places and time slots; to, when the meeting format is determined to be the online format, transmit a generation request for meeting setting information to an external processing device providing an online meeting service via a communication network, acquire connection information for an online meeting returned from the external processing device, and generate online meeting notification information including the connection information; to register the face-to-face meeting notification information or the online meeting notification information in a schedule management storage area and to transmit the face-to-face meeting notification information or the online meeting notification information to the user terminal; and to transmit a prompt sentence to the generative AI model to format or revise a text of the meeting notification information into a predetermined writing style and to apply natural language text returned from the generative AI model as the meeting notification information. This enables the server to implement an integrated, machine-controlled pipeline in which natural-language prompt sentences are automatically converted into structured scheduling decisions, coordinated accesses to internal and external resources, and context-appropriate meeting notifications, thereby improving the technical functioning of the computer system by reducing manual input, decreasing processing latency, enhancing reliability of meeting-format determination, and dynamically adapting notification content through generative AI-based text generation and refinement.

The term “system” refers to an information processing arrangement including at least one server, one or more terminals, and one or more storage resources, configured to execute the functions described in the claims.

The term “processor” refers to one or more hardware processing units, such as a central processing unit or a processing core, capable of executing program instructions to perform the claimed operations.

The term “user terminal” refers to an information processing device operated by a user, such as a personal computer, a tablet device, a smartphone, or another communication device, configured to transmit input information and receive meeting notification information.

The term “input information” refers to data received from the user terminal, including at least one prompt sentence and optionally additional parameters such as time constraints, participant information, and location preferences.

The term “prompt sentence” refers to a natural language expression or similar textual instruction provided by the user, which is supplied to a generative AI model or other analysis mechanism to specify a request related to meeting scheduling or meeting notification generation.

The term “generative AI model” refers to a computer-implemented model that uses machine learning algorithms, such as a large language model, to generate or analyze natural language text in response to input data including prompt sentences.

The term “analysis request” refers to a data structure or message transmitted from the processor to the generative AI model, including at least the input information, and instructing the generative AI model to perform analysis and return an analysis result.

The term “analysis result” refers to information returned from the generative AI model, including at least interpreted user intent, meeting-related attribute information, and optionally structured data suitable for rule-based processing.

The term “meeting-related attribute information” refers to information indicating characteristics of a meeting, including, for example, a meeting purpose, a desired time range, a preferred format, participant attributes, and location conditions, as derived from the analysis result.

The term “predetermined rule set” refers to a collection of machine-readable rules stored in a storage device, the rules defining conditions and logic for determining a meeting format, selecting resources, and controlling subsequent processing steps.

The term “meeting format” refers to a classification of how a meeting is conducted, including at least a face-to-face format in which participants gather at a physical meeting place and an online format in which participants connect via a communication network.

The term “face-to-face format” refers to a meeting format in which participants attend in person at one or more physical meeting places.

The term “online format” refers to a meeting format in which participants attend remotely via a communication network using an online meeting service or similar communication service.

The term “information storage device” refers to a hardware storage resource, such as a database system or a file storage system, configured to store reservation information of meeting places, schedule information of participants, and schedule management information.

The term “reservation information of meeting places” refers to stored data indicating the availability, occupancy, and reservation status of physical meeting places over time.

The term “schedule information of participants” refers to stored data representing time periods during which meeting participants are available or unavailable, as used for scheduling meetings.

The term “available meeting places and time slots” refers to combinations of physical meeting locations and time intervals that are determined, based on reservation information and schedule information, to be free for scheduling a meeting.

The term “face-to-face meeting notification information” refers to data representing a meeting notification for a face-to-face format, including at least an indication of a meeting place and a time slot, and optionally additional meeting details.

The term “communication network” refers to a wired or wireless data communication infrastructure, such as the Internet, a local area network, or a wide area network, enabling data exchange between the server, the user terminal, and external processing devices.

The term “external processing device” refers to a computer system or service separate from the server, accessible via the communication network, and configured to provide an online meeting service or related functionality.

The term “online meeting service” refers to a communication service that provides functions for creating, managing, and conducting online meetings, including generation of connection information for remote participants.

The term “meeting setting information” refers to information used to configure an online meeting on the external processing device, including parameters such as meeting time, subject, and security settings.

The term “connection information for an online meeting” refers to data that enables participants to join an online meeting, including at least a network address, an identifier, and optionally authentication or access information.

The term “online meeting notification information” refers to data representing a meeting notification for an online format, including at least connection information for an online meeting and optionally additional meeting details.

The term “schedule management storage area” refers to a logical or physical storage region in the information storage device that holds records of scheduled meetings, including associated notification information.

The term “meeting notification information” refers to information to be provided to a user regarding a meeting, including at least meeting format, time, and either a meeting place or connection information, and optionally descriptive text.

The term “predetermined writing style” refers to a specified linguistic style, tone, or format, such as a polite business style or concise notification style, to which the meeting notification information is to be conformed.

The term “user utterances or textual expressions” refers to speech-derived text, chat messages, or other natural language input provided by the user, which may be analyzed for emotional state.

The term “emotion analysis processing” refers to computational processing that estimates an emotional state of the user based on user utterances or textual expressions, using algorithms such as sentiment analysis or emotion classification.

The term “estimated emotional state” refers to a classification or score representing an inferred emotional condition of the user, such as positive, neutral, negative, or more detailed emotional categories.

The term “expression style of the meeting notification information” refers to the manner in which the meeting notification information is worded, including choices of phrasing, politeness level, and level of detail.

The term “important terms” refers to words, phrases, or tokens extracted from the input information or the analysis result that are identified as being significant for determining meeting characteristics.

The term “meeting purpose” refers to an intended objective or topic of a meeting, such as a review, a briefing, or a discussion, as inferred from the input information or analysis result.

The term “participant attributes” refers to characteristics of meeting participants, such as roles, departments, or locations, that may affect meeting format or resource selection.

The term “candidate implementation locations” refers to potential physical or virtual locations, such as meeting rooms or online spaces, that are considered as possible venues for conducting a meeting.

The term “candidate time slots” refers to potential time intervals during which a meeting may be scheduled, prior to final selection based on rule evaluation and resource availability.

In one embodiment, a server executes a meeting notification generation program on hardware comprising at least one central processing unit, a main memory, a non-volatile storage device, and a network interface. The server can include, for example, an x86-compatible processor, a random access memory, a solid-state drive, and an Ethernet or wireless network controller. The server operates under a general-purpose operating system, such as a UNIX-like operating system, and runs application software implemented in a programming language such as Python or JavaScript. The server further accesses one or more hardware accelerators, such as a graphics processing unit, for executing a generative AI model used in the analysis of natural language input.

The server stores program modules in the non-volatile storage device. The program modules include a web application module, a generative AI interface module, a rule evaluation module, a schedule management module, a notification generation module, an emotion analysis module, and a database access module. Each program module executes as one or more processes or threads under the operating system and communicates using inter-process communication primitives provided by the operating system.

The terminal functions as a user-operated device and can be realized by a personal computer, a smartphone, a tablet, or another communication device. The terminal executes client software, such as a web browser or a dedicated application, that displays a user interface for entering a prompt sentence. The terminal captures user input through an input device, such as a keyboard or a touch screen, and transmits the entered text to the server via a communication network using a protocol such as HTTPS.

The user enters natural language instructions into the terminal. The user can input, for example, the following prompt sentences:

“Please determine the format of the next meeting and create a notification.”

“Decide whether the next project kickoff should be online or in-person, and if in-person, propose available rooms tomorrow afternoon; if online, create a meeting link and include it in the notification.”

“Determine if our weekly review should be face-to-face or online next Monday, and generate a polite invitation message.”

The terminal transmits the prompt sentence and, optionally, associated metadata such as user identifiers, time zone information, and preferred languages to the server as structured data. The terminal can format the data as a request payload and send it to a designated application endpoint of the server.

The server receives the request at the web application module and stores the prompt sentence and metadata in main memory. The server maps the received data into internal data structures, such as records containing fields for user identifier, prompt text, timestamp, and context parameters. The server then passes the structured data to the generative AI interface module.

The server utilizes the generative AI model as a multi-layer neural network implemented on the hardware accelerator. The generative AI model can be realized as a transformer-based architecture including an embedding layer, multiple self-attention layers, feed-forward layers, and an output projection layer. The server maintains model parameters, including weight matrices and bias vectors, in a model storage area accessible by the hardware accelerator. The server loads token embeddings and model parameters into device memory and executes forward propagation for each input sequence.

The server converts the prompt sentence into a sequence of tokens using a tokenizer, such as a subword tokenizer. The server maps each token to a numerical vector using the embedding layer. The server then applies multiple attention heads, each computing scaled dot-product attention over the token sequence. The server aggregates attention outputs, passes them through nonlinear activation functions, and propagates them through multiple transformer blocks. The server obtains context-aware representations of the prompt sentence and passes them to an output layer that generates probability distributions over output tokens.

The server configures the generative AI model to output structured control information instead of arbitrary text. The server constructs an internal instruction sequence as part of the model input, specifying that the model should identify meeting-related attribute information, such as meeting format indications, time constraints, location cues, and participant properties.

The server supplies this instruction text and the user's prompt sentence together to the generative AI model. The server constrains the model output to a machine-interpretable structure, such as key-value pairs encoded in a fixed textual pattern, and then parses the output into structured data. By enforcing a structured output format, the server improves the reliability and speed of downstream processing because the server avoids repeated heuristic parsing.

The server initially trains the generative AI model on a training dataset that includes pairs of prompt sentences and labeled attribute information. The server performs supervised learning using an error function such as cross-entropy between predicted token sequences and target token sequences. The server updates the model parameters using an optimization algorithm such as stochastic gradient descent or an adaptive optimizer. The server may further apply fine-tuning using domain-specific meeting data and prompt-response pairs to adapt the model to the specific scheduling domain. During training, the server evaluates gradients on mini-batches of training examples and updates weights stored in the model storage area, thereby reducing the error function and improving attribute extraction accuracy. This training and fine-tuning pipeline yields a model specialized in extracting meeting-related attribute information from prompt sentences.

The server, after receiving the analysis result from the generative AI model, invokes the rule evaluation module. The server stores a predetermined rule set in an information storage device, such as a relational database or a configuration file. The rule set includes conditions that refer to attributes extracted from the prompt sentence. For example, the rules can specify that if the number of remote participants exceeds a threshold, or if a specific online platform is mentioned, the meeting format is determined as online; if a specific meeting room or building is explicitly mentioned, the meeting format is determined as face-to-face. The server loads the applicable rules into memory as a decision tree or rule table and performs deterministic evaluation over the attributes produced by the generative AI model.

The server uses this separation between model-based extraction and rule-based determination to improve technical behavior. The generative AI model operates as a probabilistic extractor of semantic attributes from unstructured natural language, while the rule evaluation module performs deterministic, verifiable logic for format determination and resource selection. By delegating feature extraction to the neural model and maintaining deterministic rules for decisions, the server reduces computation required for exhaustive natural language pattern matching in the rule engine, shortens decision latency, and allows easier updating of format-selection logic without retraining the model.

The server, when the rule evaluation module identifies the meeting format as face-to-face, calls the database access module. The server connects to an information storage device that stores reservation information of meeting places and schedule information of participants. The server uses structured query language statements to retrieve time ranges during which specified meeting rooms are unoccupied and participants are available. The server performs join operations between a meeting room table and a participant schedule table and computes intersection intervals. The server represents candidate time slots as interval objects in memory and filters them based on constraints such as minimum meeting duration and buffer time requirements.

The server then invokes the notification generation module to produce face-to-face meeting notification information. The server uses a template mechanism that stores a base text pattern for notification messages. The server substitutes variable fields such as meeting place name, time slot, date, and meeting purpose. The server can generate a textual message including content such as “Conference room B is available from 14:00 to 16:00 for the next meeting.” The server can also generate supplemental structured data such as identifiers of selected rooms and time slots for registration in a schedule management storage area.

The server, when the rule evaluation module identifies the meeting format as online, interfaces with an external processing device providing an online meeting service. The server uses the communication network to send an API request to the external processing device, including parameters such as meeting subject, time, duration, and host identifier. The external processing device returns meeting setting information such as a connection URL, a meeting identifier, and an access code. The server parses the returned data, verifies that the required fields are present, and stores them in the schedule management storage area.

The server then generates online meeting notification information using the notification generation module. The server embeds the connection information into a text template, producing content such as “The online meeting URL is https://example.com/meeting. The meeting ID is 123456, and the password is abc 123. The meeting will start at 14:00.” The server registers this online meeting notification information in the schedule management storage area along with a unique meeting record, which references the external meeting settings stored in the information storage device.

The server, in some embodiments, applies an emotion analysis module to user utterances or textual expressions. The server implements emotion analysis using a separate neural network classifier or by leveraging latent features generated by the generative AI model. The server extracts text segments from the input information and converts them into embeddings. The server feeds these embeddings into a classifier trained to categorize emotional states. The classifier uses a loss function such as cross-entropy between predicted emotion classes and labeled training data. The server trains the classifier using a dataset of utterances annotated with emotional labels and updates its weights through backpropagation and gradient descent.

The server then uses the estimated emotional state as an additional input to the notification generation module, adjusting expression style, politeness level, or length of the notification. For example, when the estimated emotional state indicates stress or urgency, the server can generate a more concise and direct notification to reduce cognitive load on the user.

The server, in order to refine meeting notification text, uses the generative AI model again as a style conversion tool. The server constructs a prompt sentence addressed to the generative AI model, such as “Rewrite the following meeting notification in polite business English: Conference room B is available from 14:00 to 16:00 for the next meeting.” The server includes the preliminary notification text and instructs the model to maintain factual information while adjusting tone and style. The server parses the output text and replaces the preliminary text in the notification information with the refined text. This controlled use of the generative AI model reduces manual editing tasks and improves consistency of notification style across the system.

The server achieves technical improvements beyond human manual work by optimizing computation paths and data structures. The server maintains the prompt sentences and analysis results in a normalized data schema, reducing redundancy and simplifying indexing and retrieval. The server employs caching strategies for frequent rule evaluations and for repeated calls to the generative AI model that share similar context, thereby reducing inference latency and network traffic to external model endpoints. The server can batch multiple analysis requests into a single model call when appropriate, thus improving utilization of the hardware accelerator and lowering overall energy consumption.

The server achieves accuracy improvements in meeting format determination because the combination of neural attribute extraction and deterministic rule evaluation reduces misclassification due to ambiguous language. The server quantifies accuracy through evaluation on test datasets and adjusts rules and training parameters accordingly. The separation of roles also permits independent refinement of the neural model and the rule set: the server can retrain the model to better capture new language patterns without changing the rules, or modify the rules to adapt to organizational policies without retraining the model.

The server, by integrating access to internal reservation information and external online meeting services into a single processing flow, reduces communication overhead and consistency errors. The server performs atomic updates in the schedule management storage area so that meeting records, room reservations, and online connection information remain synchronized. The server can use transaction mechanisms in the database to ensure that, if any part of resource acquisition fails, the meeting record is either rolled back or marked with a consistent error state. This improves data integrity and reliability of the scheduling process.

The server applies non-conventional processing orders compared to typical human procedures. For example, the server can pre-filter candidate time slots using approximate availability data before executing detailed per-participant checks, reducing computational load. The server can also apply incremental updating of notification content: when new participant information is added, the server can re-evaluate only affected attributes through partial calls to the generative AI model, instead of recomputing full outputs. These algorithmic strategies exploit the machine's ability to operate on structured attribute representations and to orchestrate complex data flows that are not feasible or efficient for manual workflows.

The terminal and the server cooperate to provide real-time or near real-time feedback to the user. The terminal receives meeting notification information from the server and displays it on a graphical user interface. The terminal can highlight key information such as meeting format, time, meeting place or connection URL, and can provide interactive elements allowing the user to confirm, modify, or share the notification. The terminal may also, in some embodiments, display intermediate results, such as the proposed format, allowing the user to override decisions. Changes made by the user are transmitted back to the server, which can update the schedule management storage area and, if necessary, re-invoke the generative AI model for text adjustments.

In alternative embodiments, the server can deploy different types of generative AI models.

The server can use smaller models for on-premises deployment when hardware resources are constrained, or larger models hosted on remote accelerators when highly accurate attribute extraction is desired. The server can also combine outputs from multiple models, such as a large general-purpose model and a smaller domain-specific classifier, and aggregate their outputs through a voting or weighting mechanism. This model composition enables a trade-off between resource consumption and accuracy.

The server, in another embodiment, can implement the rule set as a learned decision structure.

The server can log model outputs and downstream scheduling outcomes and then apply machine learning to infer optimal rules or thresholds. However, even when rules are learned, the server maintains them as explicit, inspectable structures distinct from the generative AI model parameters, preserving the technical advantages of having a clear control layer. Through these embodiments, the server, terminal, and user collaborate in a computer-implemented environment that transforms unstructured natural language prompt sentences into structured, actionable meeting notifications. The system does not merely automate a human scheduling procedure but introduces a specialized computational architecture combining neural feature extraction, deterministic rule evaluation, database-driven resource allocation, and model-based text refinement. This architecture improves processing speed, decision accuracy, data consistency, and communication efficiency within the computer system and across networked devices, thereby providing a concrete technical implementation that can be realized by one skilled in the art.

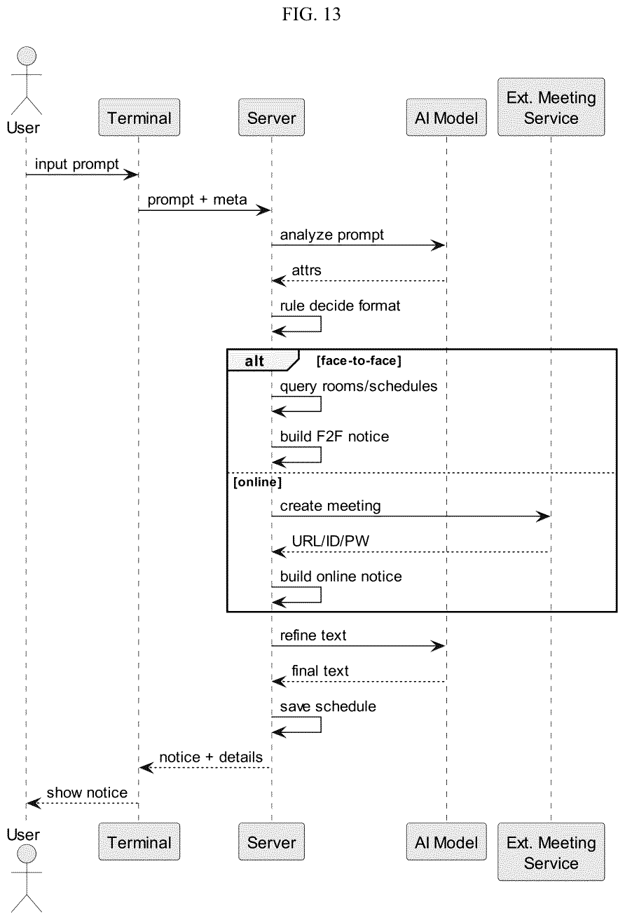

The following describes the processing flow using FIG. 13.

### Step 1:

The user operates the terminal to launch a meeting scheduling interface and inputs a prompt sentence such as “Please determine the format of the next meeting and create a notification.” The terminal receives the user's keystrokes or touch input as character data, aggregates the characters into a text string, and displays the text in an input field.

Input: raw user input events (keystrokes, touch events).

Output: a completed prompt sentence stored as a text string on the terminal.

### Step 2:

The terminal transmits the prompt sentence and associated metadata to the server via a network request.

The terminal packages the prompt sentence, a user identifier, a timestamp, and optional context information into a structured request and sends it over HTTPS to an application endpoint of the server.

Input: the prompt sentence text and local context data (user ID, time zone, language).

Output: an HTTPS request containing the structured input information delivered to the server.

### Step 3:

The server receives the HTTPS request and normalizes the input information into internal data structures.

The server parses the request body, validates the presence of mandatory fields, and maps the prompt sentence and metadata into a record containing fields such as prompt_text, user_id, and request_time, which is stored in main memory and optionally logged to persistent storage.

Input: the structured request from the terminal.

Output: an in-memory request record representing the prompt sentence and its context.

### Step 4:

The server prepares an input sequence for the generative AI model by combining an instruction text with the prompt sentence.

The server concatenates a predefined instruction, such as “Extract meeting-related attributes from the following prompt,” with the user's prompt sentence and converts the combined text into a sequence of tokens using a tokenizer; the server then stores the token sequence in a model input buffer.

Input: the prompt_text field from the request record and a predefined instruction template.

Output: a tokenized input sequence ready to be processed by the generative AI model.

### Step 5:

The server performs neural inference using the generative AI model to analyze the prompt sentence.

The server loads token embeddings and model parameters into the hardware accelerator, executes forward propagation through the transformer layers, computes attention weights and hidden states, and generates an output token sequence that encodes meeting-related attribute information in a constrained textual format.

Input: the tokenized input sequence in the model input buffer.

Output: a model output sequence representing an analysis result in text form.

### Step 6:

The server parses the model output sequence to obtain structured meeting-related attribute information.

The server applies a text parser that recognizes delimiters, keys, and values in the model output, converts textual fields such as “format: online” or “time_window: tomorrow afternoon” into typed data (enumerations, date-time ranges, flags), and stores these attributes in an analysis result object.

Input: the model output sequence from the generative AI model.

Output: an analysis result object containing structured attributes such as meeting_format, time_constraints, location_hints, and participant_properties.

### Step 7:

The server determines the meeting format by evaluating a predetermined rule set over the analysis result object.

The server loads a rule table into memory, applies conditional checks such as “if location hints include a physical room name then meeting_format=face_to_face,” and resolves conflicts according to priority ordering; the server writes the final meeting format decision into a decision record.

Input: the structured analysis result object and the rule set.

Output: a decision record indicating the resolved meeting format (face-to-face or online) and any supporting reasoning flags.

### Step 8:

The server, when the meeting format is face-to-face, queries the reservation database to obtain available meeting places and time slots.

The server constructs database queries using participant identifiers and time_constraints, joins a meeting_room table with a participant_schedule table, computes intersections of free intervals, and filters out rooms that do not meet capacity requirements; the server assembles a list of candidate room-time combinations.

Input: the decision record specifying face-to-face format, participant data, and time constraints.

Output: a candidate list object containing available meeting places and corresponding time slots.

### Step 9:

The server generates preliminary face-to-face meeting notification information based on the candidate list.

The server selects one or more preferred room-time combinations according to a selection policy (for example, earliest available time or smallest adequate room), substitutes the selected values into a text template, and forms a notification text such as “Conference room B is available from 14:00 to 16:00 for the next meeting,” which is encapsulated in a notification data structure.

Input: the candidate list object of room-time combinations.

Output: a preliminary face-to-face notification object containing selected room, time, and textual content.

### Step 10:

The server, when the meeting format is online, invokes an external online meeting service to obtain connection information.

The server constructs an API request that includes meeting subject, scheduled time range, and host identifier, sends the request to an external processing device over the communication network, receives a response containing a meeting URL, meeting ID, and access code, and validates and stores these fields in an online meeting settings object.

Input: the decision record specifying online format and meeting attribute information (time window, purpose, host).

Output: an online meeting settings object including connection information such as URL, ID, and password.

### Step 11:

The server generates preliminary online meeting notification information based on the online meeting settings object.

The server inserts the connection information and scheduled time into a notification template, producing text such as “The online meeting URL is https://example.com/meeting. The meeting ID is 123456, and the password is abc 123. The meeting will start at 14:00,” and encapsulates this text and related metadata into an online notification object.

Input: the online meeting settings object.

Output: a preliminary online notification object containing connection information, time, and textual content.

### Step 12:

The server optionally performs emotion analysis on the user's prompt sentence to adjust the notification expression style.

The server feeds the prompt sentence into an emotion classifier, converts the text into embeddings, computes class scores for emotional categories, selects the highest scoring category as the estimated emotional state, and stores this state as an additional attribute in the decision record for later use in tone selection.

Input: the original prompt sentence text.

Output: an emotional_state attribute appended to the decision record.

### Step 13:

The server refines the notification text using the generative AI model with style-adjustment instructions.

The server composes a new prompt sentence such as “Rewrite the following meeting notification in polite business English,” appends the preliminary notification text, and tokenizes the combined text; the server then executes neural inference to obtain a revised notification text that preserves factual information but adapts tone and structure, optionally conditioned on the emotional state attribute.

Input: the preliminary notification object and style-adjustment instruction text (and optionally emotional_state).

Output: a refined notification text string produced by the generative AI model.

### Step 14:

The server updates the notification object with the refined notification text and registers the meeting in the schedule management storage area.

The server replaces the preliminary text field with the refined text, assigns a unique meeting identifier, and writes a record into a schedule table that links the meeting identifier, meeting format, time, room or connection information, and final notification text; the server commits the transaction to ensure durable storage.

Input: the preliminary notification object and the refined notification text string.

Output: a persistent schedule record containing finalized meeting and notification information.

### Step 15:

The server transmits the finalized meeting notification information to the terminal.

The server constructs a response payload containing the final notification text and structured meeting details (format, time, room or URL), serializes the payload into a response message, and sends it to the terminal via HTTPS or via a push notification service, depending on the client configuration.

Input: the persistent schedule record or corresponding notification object.

Output: a network response message carrying the finalized meeting notification information delivered to the terminal.

### Step 16:

The terminal receives the finalized meeting notification information and presents it to the user.

The terminal parses the response payload, extracts the notification text and structured fields, updates its user interface to display the meeting format, time, and room or connection URL, and provides interactive controls such as buttons for adding the meeting to a local calendar or for opening the online meeting link.

Input: the response message containing the finalized meeting notification information.

Output: a rendered user interface on the terminal screen showing the meeting details to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In modern electronic communication services that provide schedule management functions, a processor must interpret natural-language input from users, decide an appropriate meeting format, and generate meeting notifications that include correct resource information such as physical meeting rooms or online conference links. Conventional systems typically rely on simple rule-based parsing of user input and manual configuration by users. As a result, these systems suffer from several technical problems.

First, conventional systems exhibit low robustness and accuracy when interpreting unstructured or ambiguous natural-language input. Simple keyword matching fails when users freely describe meetings in complex sentences or when multiple potential formats (for example, in-person and online) are implied. This leads to incorrect or incomplete internal representations of meeting specifications in memory and persistent storage, degrading the reliability of downstream scheduling and notification generation operations executed by the processor.

Second, conventional systems do not efficiently integrate external service interfaces for schedule management and online communication. For example, when a meeting is determined to be in-person, the system often does not automatically query external schedule services to compute and reserve an available physical space. When a meeting is online, the system frequently requires users to manually create and paste connection links from external communication-meeting services. This manual coupling results in fragmented data across multiple subsystems, redundant network requests, and increased latency, thereby reducing overall computational efficiency and consistency of the meeting data structures.

Third, existing systems seldom exploit generative AI models in a controlled, system-level manner to assist both in semantic analysis and in generation of machine-consumable and human-readable notification content. When generative AI is used merely as a text generator, there is a risk that the generated content does not align with structured constraints such as required fields, external service identifiers, and internal rule sets. This mismatch forces additional corrective logic or manual intervention, increasing processor load and complexity, and reducing determinism of the scheduling pipeline.

Fourth, conventional systems inadequately integrate emotion analysis into the technical process of notification generation. Even when sentiment is roughly estimated, the systems do not feed emotion-type information and emotion-intensity information back into the content-generation and decision-making pipeline in a structured way. Consequently, the notification content does not adapt to the user's emotional state, and the system fails to parameterize generative models or templates based on emotion data. This leads to a rigid, one-size-fits-all generation of messages and underutilizes available computational signals.

Accordingly, there is a need for a system and method in which a processor can (i) construct and submit prompt sentences to a generative AI model to obtain structured analysis result data, (ii) combine such analysis result data with natural language processing and preset rule sets to reliably determine meeting format information, (iii) automatically orchestrate external schedule management and communication-meeting services to generate physical-space reservation information or communication-meeting information, and (iv) incorporate emotion analysis into the generation of meeting notification content. By doing so, the system can improve the internal data-processing pipeline, reduce user intervention, and enhance the correctness, efficiency, and adaptability of computer-implemented scheduling operations.

The specific processing by the specific processing unit 290 of the data processing device 12 in Application Example 2 is realized by the following means.

The present invention provides a server comprising a processor configured to receive, from a user terminal, input information for creating a meeting notification; to generate a prompt sentence including the input information and an analysis request; to input the prompt sentence to a generative AI model and obtain analysis result data; to apply a natural language processing technique to the analysis result data and the input information to extract linguistic expressions; to determine meeting format information indicating whether a meeting is to be conducted in an in-person format or an online format based on the extracted linguistic expressions and a preset rule set; to generate, in accordance with the meeting format information, physical-space reservation information by acquiring available-time information of a physical space using a schedule-information acquisition function of an external schedule management service when the in-person format is determined, and to generate communication-meeting information including connection-link information and identification information using a meeting-information generation function of an external communication-meeting service when the online format is determined; to automatically generate meeting notification content including meeting-date-and-time information, participant information, location information or connection information based on the meeting format information, the physical-space reservation information or the communication-meeting information, and the analysis result data, and to register the meeting notification content as schedule information in a schedule management function; and to transmit the meeting notification content to the user terminal so as to cause the meeting notification content to be displayed via the user terminal. This enables the server to implement an improved, end-to-end scheduling pipeline in which natural-language user input is converted into structured meeting specifications via coordinated use of generative AI models, natural language processing, rule-based decision logic, external resource-reservation interfaces, and emotion-aware content generation, thereby enhancing the accuracy, efficiency, and adaptability of computer-based meeting notification generation.

The term “processor” refers to a hardware or virtual computation unit, such as a central processing unit or a processing core of an information processing apparatus, that executes instructions of a program to perform data processing, control, and communication operations.

The term “user terminal” refers to an electronic apparatus, such as a mobile device, a portable terminal, or a stationary terminal, that provides a user interface for inputting information and displaying information, and that communicates with a server via a communication network.

The term “input information” refers to data representing content for creating a meeting notification, including at least one of text data, time data, participant data, and preference data, which is transmitted from the user terminal to the server.

The term “meeting notification” refers to information indicating details of a meeting, including at least meeting-date-and-time information, participant information, and either location information or connection information, that is generated by the server and provided to the user terminal or to participants.

The term “prompt sentence” refers to a text sequence or data structure that includes at least a representation of the input information and an analysis request, and that is supplied to a generative AI model to cause the generative AI model to perform a predetermined analysis or generation process.

The term “generative AI model” refers to a machine-learning model, such as a language model or a multimodal model, that generates or analyzes data in response to an input prompt sentence, and outputs analysis result data or generated content.

The term “analysis result data” refers to data output from the generative AI model in response to the prompt sentence, the data including at least one of semantic labels, inferred attributes, proposed meeting formats, and recommended meeting conditions.

The term “natural language processing technique” refers to an information processing method that automatically analyzes text data expressed in a human language, including at least one of tokenization, part-of-speech tagging, syntactic analysis, semantic analysis, keyword extraction, and entity recognition.

The term “linguistic expressions” refers to words, phrases, or other language elements extracted from the input information and the analysis result data by the natural language processing technique, which are used as features for determining meeting format information and other attributes.

The term “meeting format information” refers to data indicating how a meeting is to be conducted, including at least a classification between an in-person format and an online format, and optionally including a hybrid format or additional format attributes.

The term “preset rule set” refers to a collection of decision rules, thresholds, and conditions, stored in a memory of the server, that are referenced by the processor to determine meeting format information and meeting-execution conditions based on linguistic expressions, analysis result data, and other parameters.

The term “in-person format” refers to a meeting format in which participants gather in a physical space, such as a room or facility, and interact face-to-face.

The term “online format” refers to a meeting format in which participants connect remotely via a communication network using an online communication-meeting service, and interact through audio, video, or messaging channels.

The term “physical space” refers to a location resource, such as a meeting room, a conference hall, or another facility, that can be reserved for in-person participation in a meeting.

The term “available-time information” refers to schedule data indicating time periods during which a physical space or other resource is free or occupied, the data being obtainable from an external schedule management service.

The term “schedule management service” refers to an external information processing service that maintains and provides schedule information for users, resources, or facilities, and that offers a schedule-information acquisition function accessible via a communication interface.

The term “schedule-information acquisition function” refers to a function or interface of the schedule management service that, in response to a request from the server, returns schedule information including available-time information of a physical space or other resource.

The term “physical-space reservation information” refers to data representing a reservation of a physical space for a meeting, including at least a space identifier, a reserved time range, and an association with a meeting record.

The term “communication-meeting service” refers to an external service that provides communication sessions for online meetings via a communication network, and that offers a meeting-information generation function to create connection-link information and identification information.

The term “meeting-information generation function” refers to a function or interface of the communication-meeting service that, in response to a request from the server, generates communication-meeting information including connection-link information and identification information for an online meeting.

The term “communication-meeting information” refers to data used to access an online meeting, including at least connection-link information, identification information, and optionally authentication information or access-control parameters.

The term “connection-link information” refers to network access information, such as a uniform resource locator or a network address, that enables a user terminal to connect to an online meeting provided by the communication-meeting service.

The term “identification information” refers to data that uniquely or semi-uniquely identifies an online meeting session, such as a meeting identifier, a conference code, or similar identification data.

The term “meeting-date-and-time information” refers to temporal data associated with a meeting, including at least a start time, an end time, and optionally a date, a time zone, and recurrence information.

The term “participant information” refers to data representing participants of a meeting, including at least one of account identifiers, contact addresses, user roles, and attribute data of the participants.

The term “location information” refers to data describing a physical location for an in-person meeting, including at least a room name, a facility identifier, or an address, and optionally including navigation-related information.

The term “connection information” refers to data required for a user terminal to access an online meeting, including at least connection-link information and identification information, and optionally including authentication information or access instructions.

The term “meeting notification content” refers to a data structure or text content that includes at least meeting-date-and-time information, participant information, and location information or connection information, and that is suitable for presentation to a user as a meeting invitation or reminder.

The term “schedule information” refers to data stored in a schedule management function representing an event, such as a meeting, including at least identifiers, temporal information, and associated metadata such as participants and resources.

The term “schedule management function” refers to a software function executed by the server or an external service that manages creation, update, retrieval, and deletion of schedule information for events and resources.

The term “emotion-analysis algorithm” refers to a computational algorithm that processes user input data, such as text information, voice information, or image information, to output emotion-type information and emotion-intensity information.

The term “emotion-type information” refers to categorical data indicating a type of emotion, such as positive, negative, or neutral, or more granular categories such as joy, anxiety, or frustration, derived from user input data.

The term “emotion-intensity information” refers to quantitative or ordinal data indicating a degree or strength of an emotion associated with user input data.

The term “wording, expressions, and tone” refers to characteristics of meeting notification content at a linguistic level, including choice of words, sentence structures, politeness level, and overall emotional style, which can be modified based on emotion-type information and emotion-intensity information.

The term “candidate meeting-date-and-time information” refers to one or more possible time slots for a meeting, represented as temporal data prior to final selection of a specific slot.

The term “participant-attribute information” refers to attribute data relating to participants, including at least one of roles, time-zone information, availability patterns, or other metadata used to recommend meeting-execution conditions.

The term “available-resource information” refers to data indicating resources that may be used for a meeting, such as physical spaces, communication channels, or devices, and their availability.

The term “meeting-execution conditions” refers to parameters specifying how and under what constraints a meeting is to be executed, including at least a selected time slot, a selected meeting format, allocated resources, and access conditions.

The term “user” refers to any person or entity that interacts with the system through a user terminal to request creation, modification, or viewing of meeting notifications.

The term “voice information” refers to audio data representing spoken utterances input by the user, which may be analyzed by the emotion-analysis algorithm or other processing components.

The term “image information” refers to still-image data or moving-image data, such as facial images or video frames, captured from the user or a surrounding environment, which may be analyzed by the emotion-analysis algorithm or another recognition process.

In one embodiment, a server executes a meeting-notification generation system on a hardware platform including at least one processor, a main memory, a non-volatile storage device, and a network interface. The server operates under control of an operating system, for example a general-purpose server operating system, and runs application software written in a high-level language such as Python and a web-application framework. A plurality of user terminals, such as smartphones, tablet devices, and personal computers, connect to the server via a communication network and provide user interfaces through native applications or web browsers.

Server stores program modules in the non-volatile storage device. These program modules include at least: a communication module, a natural language processing module, a rule-based decision module, an external schedule-service integration module, an external communication-meeting-service integration module, an emotion-analysis module, a generative-AI interface module, and a notification-generation module. Server loads these modules into main memory and executes them by the processor.

Server uses a relational database management system, for example a database engine, to store structured data. The structured data includes user accounts, meeting records, schedule information, physical-space resources, communication-meeting session data, and logs. Each meeting record is represented as a data structure including fields for meeting identifier, input information, analysis result data, meeting format information, reservation information, communication-meeting information, emotion-type information, and meeting-notification content.

Terminal executes a user-interface program that presents input forms and display elements to a user. Terminal acquires text input, date-and-time selections, participant selections, and optional voice or image input from a user, and transmits this input information to the server over a secure communication protocol. Terminal also receives meeting-notification content and associated metadata from the server and renders them on a display, and optionally triggers deep links into other applications such as calendar applications or communication-meeting clients.

Server processes input information using a specific combination of software libraries and data-processing algorithms. In one embodiment, server uses a natural language processing library such as a tokenization and part-of-speech tagging library to segment and annotate words in the input text. Server uses an additional natural language processing library such as a dependency parser and named-entity recognizer to extract linguistic expressions relevant to meeting scheduling, including temporal expressions, platform names, and references to physical locations.

Server represents the extracted linguistic expressions as feature vectors. For example, server encodes indicators such as “in-person keyword present,” “online platform keyword present,” “physical location entity present,” and “ambiguity score.” Server stores these feature vectors in the meeting record. Server applies a rule-based decision module to the feature vectors and to user-selected options. The rule-based decision module is implemented as a decision table or a directed acyclic graph of conditions, stored as configuration data in the database. By using explicit data structures for rules, server can update decision policies without modifying core code, and can evaluate rules in a deterministic and efficient manner.

Server uses a generative AI model as a separate computational component accessible through an inference API. In one embodiment, the generative AI model is a transformer-based neural network language model having multiple self-attention layers, feed-forward sub-layers, and layer-normalization components. The model is trained in advance on large-scale text corpora and fine-tuned on domain-specific scheduling data. The model parameters include multiple weight matrices for attention projections, feed-forward networks, and embedding layers. The model uses positional encodings and auto-regressive decoding to generate output sequences.

Server stores a description of the generative AI model's configuration, such as number of layers, hidden dimension size, attention heads, and vocabulary size, in a configuration repository. Although the model itself may be deployed on another computation node, server's generative-AI interface module explicitly controls how the model is used through prompt sentences. Server does not rely on opaque “AI decides” operations; instead, server constructs prompt sentences with specific fields and instructions to constrain and structure the model's output.

Server, for example, uses the following prompt sentence to request classification of meeting format when rules alone are insufficient:

“You are a scheduling assistant. Decide whether the following meeting should be in person or online.

Return exactly one word: ‘in-person’ or ‘online’.

Title: ‘Next shift meeting (Zoom)’

Description: ‘I'm a bit worried about the schedule, but I'm looking forward to discussing this.“ ”

Server passes the title and description as part of the prompt sentence, receives the generated token sequence from the generative AI model, and parses it to obtain analysis result data in the form of a categorical label. Server treats this label as one feature among others, and applies the preset rule set as an additional filter. This combined approach improves robustness compared to pure rule-based or pure model-based solutions, and reduces misclassifications caused by ambiguous phrasing.

Server also uses the generative AI model to generate human-readable notification text while enforcing technical constraints. Server constructs a structured prompt sentence including explicit placeholders for required fields:

“You are an assistant that writes meeting invitations.

Use the following data to create a clear, polite English meeting invitation:
Title: [title]
Date and time: [start] to [end], [time zone]
Participants: [participants]
Format: [in-person] or [online]
Location (if in-person): [room name and address]
Online link (if online): [URL]
User emotion: [positive/negative/neutral]

If the user emotion is positive, include a phrase such as ‘I'm looking forward to this meeting.’ If the user emotion is negative, gently mention that the organizer is currently concerned about the issue.

Return only the email body text.”

Server receives the generated text and verifies that required elements (date, time, and link or room) appear. If missing, server appends or corrects these fields from structured data. This design ensures the generative AI model operates as a constrained text generator within a larger deterministic pipeline, thereby improving correctness of notification content while leveraging natural-language fluency.

Server improves emotion-aware processing using the emotion-analysis module. In one embodiment, server uses a sentiment-analysis algorithm based on a recurrent neural network or a transformer encoder trained on labeled sentiment data. Server represents text as token embeddings and processes them through the network to produce a probability distribution over emotion classes. During training, server or an external training system minimizes a cross-entropy loss function between predicted probabilities and ground-truth labels, updating weights through gradient descent and backpropagation. Data augmentation such as synonym replacement or paraphrasing is applied to improve robustness to varying user expressions.

Server obtains emotion-type information and emotion-intensity information using this network or using a rule-augmented sentiment library. Server stores the emotion-type and emotion-intensity as part of the meeting record. Server adjusts wording, expressions, and tone of notification content based on these values. For example, server applies a lookup table of phrase templates indexed by emotion categories. For positive emotion, server selects an encouraging closing phrase; for negative emotion, server selects a supportive phrase that indicates concern. By integrating emotion analysis into structured data processing, server alters content generation parameters in a reproducible manner, not just stylistic post-processing.

Server integrates with external schedule management services and communication-meeting services using dedicated modules that call network APIs. In one embodiment, server uses a calendar API to query free/busy information for physical spaces. Server sends a time range and list of resource identifiers, receives a structured response listing busy intervals, and calculates available slots by subtracting busy intervals from the requested range. Server then selects an optimal room using a heuristic, such as minimal unused capacity difference and minimal walking distance encoded in metadata. By performing these calculations programmatically, server can avoid inefficient trial-and-error user operations and reduce communication load with the external service through batched requests.

Server similarly integrates with an online meeting API to create communication-meeting information. Server sends a structured request including meeting topic, schedule, and optional security settings, receives connection-link information and identification information, and stores these fields in the meeting record. Server uses caching and idempotent request identifiers to avoid duplicate creation of meetings, thus reducing unnecessary network calls and lowering communication overhead.

Server internal data flow is organized into modules connected through defined interfaces. Each module passes structured objects, such as feature vectors, classification results, reservation objects, and notification objects, to the next module. Server uses queues or messaging within the application framework to decouple modules and to allow asynchronous operations, thereby improving throughput and enabling load balancing across multiple processor cores or machines.

Server processes prompt sentences and generative-AI outputs using custom parsers and validators. Instead of simply displaying the raw generative text, server extracts structured annotations such as extracted time ranges, recommended formats, and confidence scores packaged in the model's output when configured. This structured extraction enables server to update data fields in the meeting record and to combine generated suggestions with rule-based overrides. The result is a hybrid inference strategy: generative AI supplies proposals and semantic interpretations, whereas the server enforces system-level consistency and policy constraints.

User interacts with the system not only through direct meeting creation forms but also through free-form AI-assistant prompts. For example, user may input:

“Please analyze everyone's schedule and decide whether the next meeting should be in person or online. Generate the optimal meeting setting automatically.”

Terminal forwards this prompt to server, which enriches the prompt with structured data from participant calendars and resource availability. Server then sends an expanded prompt sentence to the generative AI model:

“You are a scheduling assistant.

User prompt: ‘Please analyze everyone's schedule and decide whether the next meeting should be in person or online. Generate the optimal meeting setting automatically.”
Participant schedules: [structured schedule data]
Available rooms: [room list and capacities]
Available online platforms: [platform list].

Decide the best meeting format and time slot and briefly explain why.”

Server receives the explanation and the proposed format and time, converts them into candidate meeting-execution conditions, and runs the rule-based decision module to confirm feasibility. If feasible, server executes reservation and meeting-creation operations. In this way, the generative AI model contributes to search across a high-dimensional constraint space, and the server enforces technical correctness and resource consistency.

Server improves computer technology in several ways. By offloading high-level language interpretation to a transformer-based generative model while using explicit rules and structured feature vectors for final decisions, server reduces the need for brittle pattern-matching code and reduces the frequency of misclassification. By employing batched API calls and caching of external service responses, server reduces communication overhead and improves response time. By encoding decision logic and emotion-handling in structured data, server allows efficient adaptation to new policies without recompilation, improving maintainability and easing deployment of updates.

Server thereby avoids mere automation of human clerical work. Instead, server changes how computation is performed: it re-architects the internal data pipeline to use learned models as semantic preprocessors and generators, integrates them with deterministic resource-allocation algorithms, and materializes these decisions as concrete control of external digital resources (room reservations, session creation, and calendar registration). This combination results in observable technical effects such as faster end-to-end scheduling, fewer invalid or conflicting reservations, and reduced manual correction.

Alternative embodiments are possible. In one embodiment, server replaces the transformer model with a recurrent neural network-based sequence model. In another embodiment, server uses a smaller on-device model for basic classification of meeting format and a cloud-based larger generative AI model for notification text. In yet another embodiment, server extends the emotion-analysis module to process multi-modal inputs by combining features from audio spectrograms and facial landmarks, thereby improving emotion-type classification accuracy. Each of these variations still follows the same structural principle of using prompt sentences, hybrid rule-and-model decision logic, and integration with external scheduling and communication services.

In summary, server, terminal, and user cooperate through this system so that server not only interprets and generates text, but also calculates resource allocations, enforces constraints, controls external digital services, and adapts notification content based on structured emotion signals. As a result, the system provides an implementable embodiment that supports the claimed subject matter and improves the underlying computer-implemented scheduling technology.

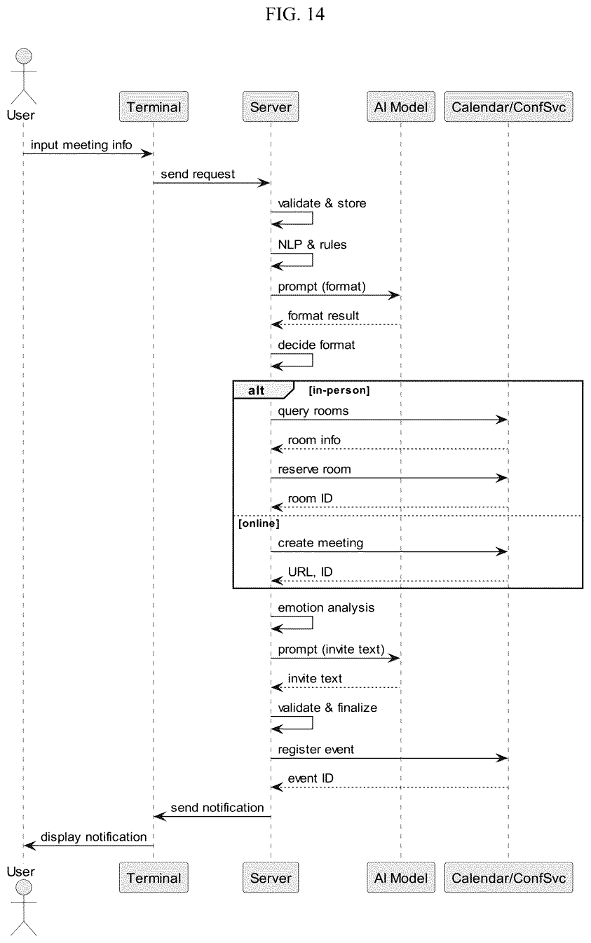

The following describes the processing flow using FIG. 14.

### Step 1:

User operates the terminal to input meeting-related information.

User enters, via input fields and text areas on the terminal, data including at least a meeting title, a candidate date and time, a participant list, and optional free-text comments, and optionally selects a preferred meeting format. The input is captured as text strings, timestamp values, and identifiers. Terminal converts this input into a structured request object (for example, a JSON object containing keys for title, datetime, participants, and comment). As a result of this data formatting operation, terminal produces a machine-readable representation of the user's meeting request.

### Step 2:

Terminal transmits the structured request to the server.

Terminal sends the structured request object to the server over a network connection using a protocol such as HTTPS. The input to this step is the structured meeting-request object created in Step 1. Terminal performs serialization of the object into a network message and attaches authentication tokens or session identifiers. The output of this step is an incoming network request received by the server that contains all user-supplied meeting parameters.

### Step 3:

Server receives and validates the meeting request.

Server accepts the incoming network request from the terminal and parses the payload to reconstruct the structured meeting-request object. The input is the serialized network message; server performs deserialization and syntax checking. Server validates each field by checking data types, allowed ranges for times, and syntactic correctness of participant identifiers. Invalid values are either corrected using default rules or cause an error response. The output of this step is a validated meeting-request object stored temporarily in memory.

### Step 4:

Server stores the raw meeting data in persistent storage.

Server writes the validated meeting-request object into a database as a new meeting record.

The input is the in-memory object from Step 3. Server assigns a unique meeting identifier, normalizes timestamp formats, and stores fields such as title, proposed time, participants, comment text, and any user-specified format into corresponding columns. This step performs data-mapping and indexing operations so that the record can be efficiently retrieved later. The output is a persistent meeting record containing the original input information.

### Step 5:

Server performs natural language preprocessing on the input text.

Server retrieves the text fields (title and comment) from the meeting record and passes them to a natural language processing module. The input is the raw text strings. Server uses tokenization algorithms to split the text into tokens, applies part-of-speech tagging, and runs named-entity recognition to detect temporal expressions, platform names, and location names. These operations transform unstructured text into a sequence of annotated tokens and entities. The output is an internal feature structure that includes token lists, entity tags, and candidate keyword flags.

### Step 6:

Server constructs a feature vector for meeting-format determination.

Server converts the annotated tokens and entities into a numerical or symbolic feature vector.

The input is the feature structure from Step 5. Server checks for the presence of keywords such as “in person,” “online,” “Zoom,” “meeting room,” and room names, and encodes each as binary or categorical features. Server may also compute an ambiguity score by counting conflicting indicators. This processing step aggregates linguistic evidence into a compact representation suitable for rule-based and model-based decision making. The output is a meeting-format feature vector associated with the meeting record.

### Step 7:

Server applies rule-based logic to tentatively determine meeting format.

Server uses the feature vector and any explicit user selection to evaluate a preset rule set. The input is the feature vector and user preference field. Server executes condition checks in a defined order, such as “if user selected online, set format to online,” or “if platform keyword is present and no physical location is present, set format to online.” These checks are implemented as comparisons and logical operations over the feature vector components. The output is a tentative meeting-format label (for example, IN_PERSON, ONLINE, or UNDETERMINED).

### Step 8:

Server generates a prompt sentence for the generative AI model when needed.

Server determines, based on the tentative meeting-format label and an ambiguity threshold, whether additional semantic analysis by a generative AI model is required. If the label is UNDETERMINED or ambiguous, server constructs a prompt sentence. The input is the meeting title, comment text, and possibly the tentative label. Server formats these elements into a textual instruction, for example:

“You are a scheduling assistant. Decide whether the following meeting should be in person or online. Return exactly one word: ‘in-person’ or ‘online’. Title: ‘[title]’ Description: ‘[comment]’.”

This step concatenates user data and fixed directives to produce a syntactically complete prompt sentence. The output is a prompt string ready to be sent to the generative AI model.

### Step 9:

Server sends the prompt sentence to the generative AI model and obtains analysis result data. Server transmits the constructed prompt sentence to a generative AI model via an inference API. The input is the prompt string from Step 8. Server encodes the prompt as a request payload, sends it over a network connection, and waits for a response. The generative AI model processes the prompt and returns a text output. Server then parses this output to extract a compact analysis result, such as a single token “in-person” or “online.” This step performs string processing and possibly normalization (for example, lowercase conversion and trimming). The output is analysis result data indicating a recommended meeting format.

### Step 10:

Server finalizes meeting format information by combining rule results and AI recommendation.

Server combines the tentative label from Step 7 and the AI recommendation from Step 9 according to consistency rules. The inputs are the tentative format label and the recommended label. Server checks for agreement; if both labels match, server sets the final meeting format to that label. If they differ, server may apply priority rules, such as trusting explicit user choice over AI recommendation, or using confidence scores when available. The data processing involves simple comparisons and selection operations. The output is final meeting-format information stored as a field in the meeting record.

### Step 11:

Server generates physical-space reservation information for in-person format.

When the final meeting format is in-person, server prepares a request to an external schedule management service. The input is the meeting time range, expected participant count, and list of candidate physical spaces. Server sends a free/busy query for each space, receives busy intervals, and computes available intervals by subtracting busy ranges from the requested time window. Server then selects a space that satisfies capacity and availability constraints using a selection heuristic. This step performs interval arithmetic and comparison operations. The output is physical-space reservation information, including space identifier and reserved time, stored in the meeting record.

### Step 12:

Server generates communication-meeting information for online format.

When the final meeting format is online, server calls an external communication-meeting service to create an online session. The input is the meeting title, scheduled time, duration, and organizer identifier. Server sends a structured creation request and receives a response containing a connection link and identification data such as a meeting identifier or passcode. Server extracts these fields and assigns them to the meeting record. This step performs field mapping and secure storage of identifiers. The output is communication-meeting information including connection-link information and identification information.

### Step 13:

Server performs emotion analysis on user input data.

Server processes user-supplied text and optionally voice or image data to determine emotion-type and emotion-intensity information. The inputs are comment text and optional audio or image samples. Server passes the text through an emotion-analysis algorithm, which may be a neural-network-based classifier that outputs probabilities for emotion classes. Server may also analyze acoustic features or facial features if multimedia data is present. Server then selects the dominant emotion type and computes an intensity value based on probabilities. The output is emotion-type information and emotion-intensity information stored in the meeting record.

### Step 14:

Server constructs a prompt sentence for generating meeting notification content.

Server prepares a detailed prompt sentence to instruct the generative AI model to draft the notification body. The inputs are the meeting format, meeting-date-and-time information, participant list, physical-space reservation information or communication-meeting information, and emotion data. Server formats these into text, for example: “You are an assistant that writes meeting invitations. Use the following data to create a clear, polite English meeting invitation: —Title: [title]—Date and time: [start] to [end], [time zone]—Participants: [participants]—Format: [in-person or online]—Location (if in-person): [room]—Online link (if online): [URL]—User emotion: [positive/negative/neutral] If the user emotion is positive, include a phrase such as ‘I'm looking forward to this meeting.’ If the user emotion is negative, gently mention that the organizer is currently concerned about the issue. Return only the email body text.”

Server thereby concatenates structured data into a single coherent instruction. The output is a second prompt sentence tailored for content generation.

### Step 15:

Server obtains draft notification content from the generative AI model.

Server sends the second prompt sentence to the generative AI model via the inference API. The input is the prompt string from Step 14. Server receives the model's generated text as a sequence of tokens or characters. Server then reconstructs the full text and applies basic sanitation, such as trimming whitespace and removing control characters. This data-processing step converts a probabilistic sequence output into a usable text string. The output is draft meeting-notification content generated by the generative AI model.

### Step 16:

Server validates and adjusts the generated notification content.

Server verifies that the generated text includes mandatory information such as date, time, and either location or connection link. The inputs are the draft notification text and the structured meeting data stored in the record. Server searches the text for patterns representing timestamps and URLs and compares them with stored values. When required elements are missing or incorrect, server inserts or replaces segments of the text with authoritative data from the meeting record. This step uses pattern matching and string replacement operations. The output is a corrected and validated notification text.

### Step 17:

Server composes a final meeting-notification object.

Server aggregates all relevant data into a notification object. The inputs are the validated notification text, meeting-date-and-time information, participant information, and either physical-space reservation information or communication-meeting information. Server constructs a composite data structure that includes subject, body, address list, and calendar-event metadata. Server assigns identifiers for tracking and status flags such as “ready to send.” The output is a fully-populated meeting-notification object stored in the database.

### Step 18:

Server registers the meeting notification in a schedule management function.

Server sends the meeting-notification object to an internal or external schedule management function. The input is the notification object from Step 17. Server issues create-event or update-event calls, passing start time, end time, title, location or link, and participant list. The schedule management function returns an event identifier, which server stores back into the meeting record. This step ensures the notification is represented as formal schedule information. The output is an updated meeting record linked to external calendar entries.

### Step 19:

Server transmits the meeting notification content to the terminal.

Server prepares a response payload for the originating terminal. The input is the meeting-notification object, including subject and body text. Server serializes this object into a response message and sends it over the network. Terminal receives the message, deserializes it, and passes the content to the user interface layer. The output is a displayed meeting notification on the terminal screen, including formatted text and interactive links.

### Step 20:

User reviews and optionally edits the notification on the terminal.

User reads the notification content shown on the terminal and may choose to modify text or participant settings. The input is the displayed notification fields. Terminal captures any edits as delta information and constructs an update request. When user confirms, terminal sends the update request back to the server. The output of this step is a user-confirmed or user-modified notification specification.

### Step 21:

Server finalizes and dispatches the meeting notification to all participants.

Server processes any user modifications and updates the meeting record accordingly. The inputs are the confirmed or edited notification data and the existing record. Server may then send email messages, push notifications, or calendar invitations to participants using integrated mail or notification services. Server batches and queues these send operations for efficiency, and records delivery status. The output is the actual delivery of meeting notifications to participant terminals and finalization of schedule entries associated with the meeting.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

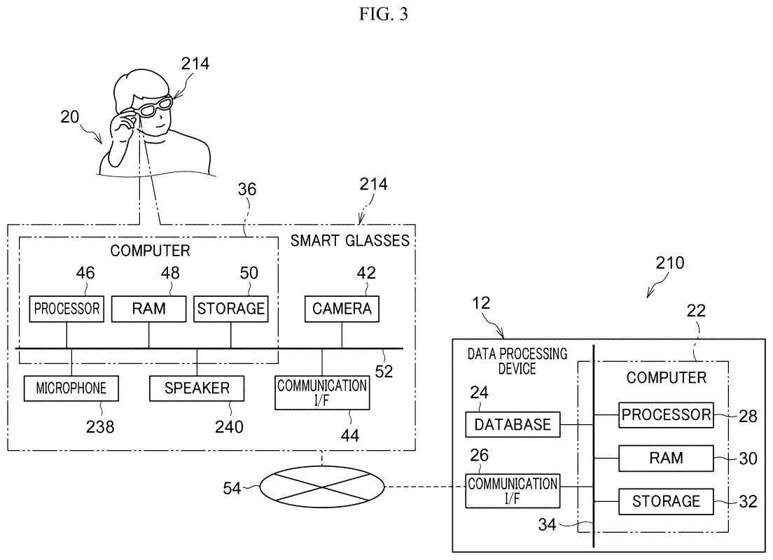

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

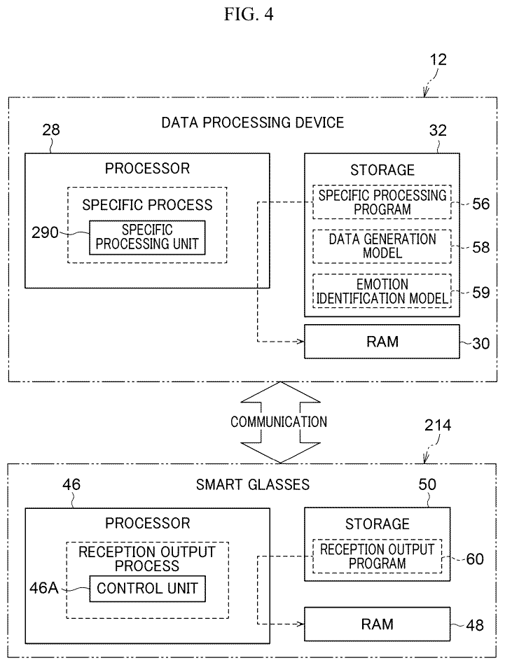

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

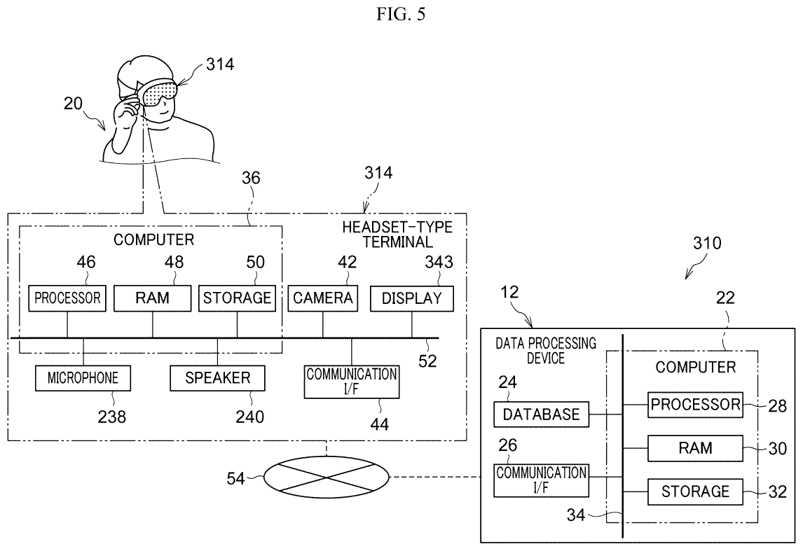

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

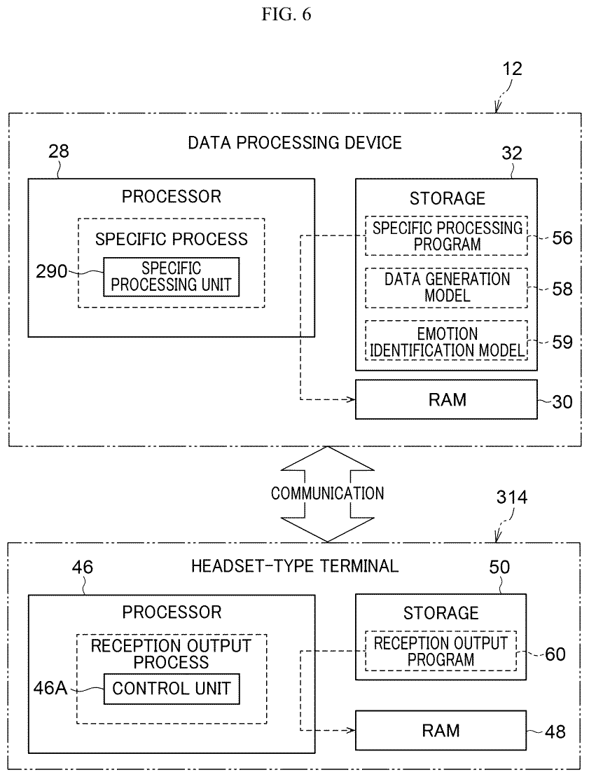

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

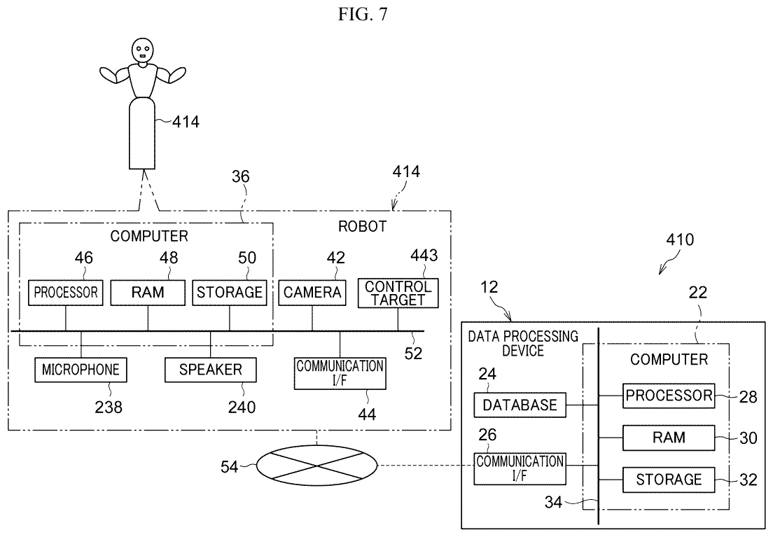

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

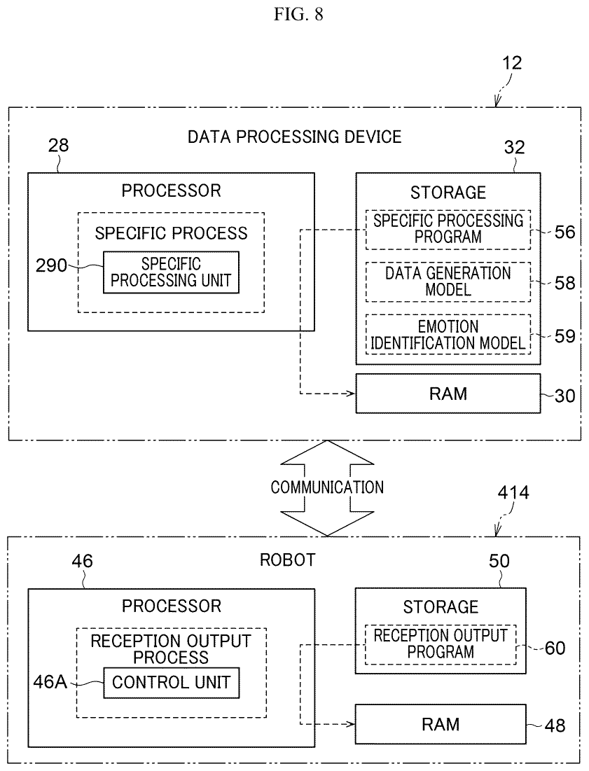

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

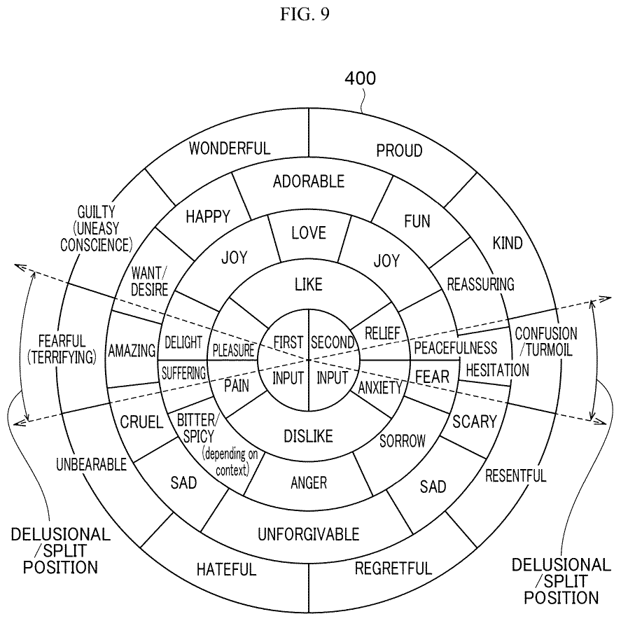

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

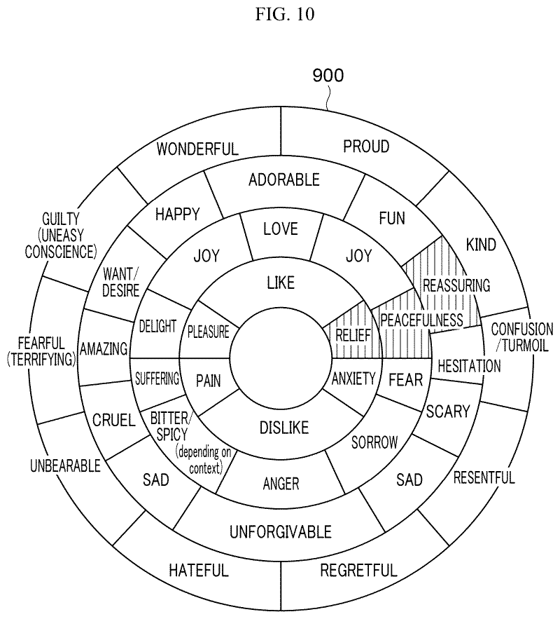

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire input information for creating a meeting notification and store the input information in a storage resource,
preprocess character information included in the input information, input the preprocessed character information to a natural language processing resource, extract phrases from the preprocessed character information, and specify candidate meeting formats including an online meeting and a face-to-face meeting on the basis of the extracted phrases, generate a prompt sentence including instruction content for causing a generative information processing model to perform determination of a meeting format based on the input information, input the prompt sentence to the generative information processing model, and obtain an analysis result including the meeting format or supplementary information relating to the meeting format from the generative information processing model,
determine the meeting format on the basis of the candidate meeting formats specified from the phrases and the analysis result, and generate meeting setting information including an online meeting identifier for an online meeting or physical location information for a face-to-face meeting in accordance with the determined meeting format, and
automatically generate content of the meeting notification on the basis of the determined meeting format, the meeting setting information, and schedule date-time information and participant information included in the input information, register the meeting notification as schedule information in an information management service having a schedule management function, and transmit notification information to participants on the basis of the schedule information.

### (Supplementary 2)

The system according to supplementary 1, wherein the processor is configured to apply an emotion analysis processing resource to an expression included in the input information acquired from a user, estimate an emotional state on the basis of a result of the emotion analysis, and adjust a text body or a representation style of the meeting notification in accordance with the estimated emotional state.

### (Supplementary 3)

The system according to supplementary 1,
wherein the processor is configured to use, as the natural language processing resource, an information processing resource capable of executing morphological analysis processing, part-of-speech classification processing, and rule-based phrase extraction processing, and, with reference to a rule set indicating correspondence between extracted phrases and the meeting format, extract, as important words, phrases including a name of an online meeting service, a word indicating a face-to-face meeting, and an expression determined to be equivalent thereto, and determine the meeting format on the basis of the important words.

### Application Example 1

### (Supplementary 1)

A system comprising a processor,
wherein the processor is configured to
acquire input information including work schedule information as duty information from an information terminal operated by a user, and receive the input information via electronic communication,
perform an analysis process on the received input information based on natural language processing by inputting a prompt sentence to a generative AI model so as to instruct the generative AI model to execute the analysis process, and obtain an analysis result corresponding to the input information from the generative AI model,
identify, based on the analysis result, a type of work schedule information as a shift format for the duty information included in the work schedule information, and specify a work time period corresponding to the shift format with reference to rule information stored in a storage device,
generate structured data including information relating to the specified shift format and the work time period, and input a prompt sentence including the structured data to the generative AI model so as to cause the generative AI model to generate, as a notification message for the duty information, a natural language sentence of a working time notification, and register the generated working time notification as notification information in schedule management information, and transmit the notification information to the information terminal to be displayed on the information terminal.

### (Supplementary 2)

The system according to supplementary 1,
wherein the processor is configured to
apply an emotion analysis algorithm to at least one of the analysis result obtained from the generative AI model and the input information so as to perform emotion analysis processing, and adjust at least one of a writing style, a politeness expression, and an information amount of the working time notification according to a user emotion state recognized by the emotion analysis processing.

### (Supplementary 3)

The system according to supplementary 1,
wherein the processor is configured to
execute natural language processing including morphological analysis, phrase extraction, and phrase structure analysis on the input information, determine a type of the work schedule information as the shift format by referring to the rule information based on at least one of time expression words, duration expression words, and work classification words extracted by the natural language processing, and use a determination result as a parameter in the prompt sentence to be input to the generative AI model.

### Example 2

### (Supplementary 1)

A system comprising a processor,
wherein the processor is configured to
receive input information including a prompt sentence from a user terminal and transmit the input information as an analysis request to a generative AI model to obtain an analysis result of the input information from the generative AI model,
refer to a predetermined rule set based on meeting-related attribute information extracted from the analysis result to determine whether a meeting is to be conducted in a face-to-face format or in an online format as a meeting format,
when the meeting format is determined to be the face-to-face format, execute an inquiry process to an information storage device storing reservation information of meeting places and schedule information of participants, extract available meeting places and time slots, and generate face-to-face meeting notification information including the available meeting places and time slots,
when the meeting format is determined to be the online format, transmit a generation request for meeting setting information to an external processing device providing an online meeting service via a communication network, acquire connection information for an online meeting returned from the external processing device, and generate online meeting notification information including the connection information,
register the face-to-face meeting notification information or the online meeting notification information in a schedule management storage area and transmit the face-to-face meeting notification information or the online meeting notification information to the user terminal, and
transmit a prompt sentence to the generative AI model to format or revise a text of the meeting notification information into a predetermined writing style, and apply natural language text returned from the generative AI model as the meeting notification information.

### (Supplementary 2)

The system according to supplementary 1,
wherein the processor is configured to
apply emotion analysis processing to user utterances or textual expressions included in the input information, and, in accordance with an estimated emotional state, modify content of the prompt sentence to the generative AI model or an expression style of the meeting notification information so as to adjust content of the meeting notification.

### (Supplementary 3)

The system according to supplementary 1,
wherein the processor is configured to
identify a meeting purpose, participant attributes, candidate implementation locations, and candidate time slots based on the analysis result by the generative AI model or based on important terms extracted by natural language processing, and use an identification result as conditions for referencing the rule set and for accessing meeting place reservation information or the online meeting service.

### Application Example 2

### (Supplementary 1)

A system comprising a processor,
wherein the processor is configured to
receive input information for creating a meeting notification from a user terminal, generate a prompt sentence including the input information and an analysis request, and input the prompt sentence to a generative AI model to obtain analysis result data,
apply a natural language processing technique to the analysis result data and the input information to extract linguistic expressions, and determine meeting format information indicating whether a meeting is to be conducted in an in-person format or an online format based on the extracted linguistic expressions and a preset rule set,
generate, in accordance with the meeting format information, physical-space reservation information by acquiring available-time information of a physical space using a schedule-information acquisition function of an external schedule management service when the in-person format is determined, and generate communication-meeting information including connection-link information and identification information using a meeting-information generation function of an external communication-meeting service when the online format is determined,
automatically generate meeting notification content including meeting-date-and-time information, participant information, location information or connection information based on the meeting format information, the physical-space reservation information or the communication-meeting information, and the analysis result data, and register the meeting notification content as schedule information in a schedule management function, and transmit the meeting notification content to the user terminal so as to cause the meeting notification content to be displayed via the user terminal.

### (Supplementary 2)

The system according to supplementary 1,
wherein the processor is configured to
apply an emotion-analysis algorithm to at least one of text information, voice information, and image information input by a user to obtain emotion-type information and emotion-intensity information, and adjust wording, expressions, and tone of the meeting notification content in accordance with the emotion-type information and the emotion-intensity information.

### (Supplementary 3)

The system according to supplementary 1,
wherein the processor is configured to
input, to the generative AI model, a prompt sentence including at least one of candidate meeting-date-and-time information, participant-attribute information, and available-resource information, obtain from the generative AI model analysis result data recommending the meeting format information and meeting-execution conditions, and finally determine the meeting format information and the meeting-execution conditions based on the analysis result data and the preset rule set.

What is claimed is:

1. A system comprising:
circuitry configured to:
receive, via a communication interface coupled to a packet-switched network, input information from a terminal device;
construct a natural-language prompt sentence based on the input information and supply the natural-language prompt sentence to a transformer-based generative neural network model to acquire an analysis result;
evaluate the analysis result against a rule set stored in a non-transitory storage medium to determine a format classification; and
generate, based on the format classification and the analysis result, structured notification data and transmit the structured notification data, via the communication interface coupled to the packet-switched network, to a schedule management server for registration and to the terminal device for rendering on a display.

2. The system according to claim 1, wherein the circuitry is further configured to:
normalize the input information by parsing a request body, validating mandatory fields, and mapping the input information into an internal data record comprising fields for a user identifier, a prompt text, and a request timestamp.

3. The system according to claim 2, wherein constructing the natural-language prompt sentence comprises:
concatenating a predefined instruction template with the prompt text from the internal data record; and
converting the concatenated text into a token sequence using a tokenizer compatible with the transformer-based generative neural network model and storing the token sequence in a model input buffer.

4. The system according to claim 3, wherein the transformer-based generative neural network model processes the token sequence by computing attention weights and hidden states through a plurality of transformer layers and generates an output token sequence encoding attribute information in a constrained textual format.

5. The system according to claim 4, wherein the circuitry is further configured to:
parse the output token sequence by recognizing delimiters, keys, and values to extract structured attribute information comprising at least a subject field, a participant list field, a date-time field, and a location field.

6. The system according to claim 5, wherein evaluating the analysis result against the rule set comprises:
applying natural language processing to annotate tokens in the input information with part-of-speech tags and named entity labels;
scanning the annotated tokens against pattern rules in the rule set to extract candidate format indicators with associated confidence scores; and
combining the candidate format indicators with the analysis result from the transformer-based generative neural network model using a decision algorithm to determine the format classification.

7. The system according to claim 6, wherein the format classification comprises one of an online format and an in-person format, and wherein:
when the format classification is the online format, the circuitry is further configured to transmit a request to an external conferencing service via the communication interface to obtain a meeting access link and include the meeting access link in the structured notification data; and
when the format classification is the in-person format, the circuitry is further configured to query a facility reservation database to identify an available room and include room information in the structured notification data.

8. The system according to claim 1, wherein the circuitry is further configured to:
apply an emotion estimation neural network classifier to at least one of text data and audio data received from the terminal device to compute a probability distribution over a set of emotion categories; and
adjust content of the structured notification data based on a dominant emotion category selected from the set of emotion categories.

9. The system according to claim 8, wherein adjusting the content of the structured notification data comprises:
modifying a tone parameter of a notification text generation template in response to the dominant emotion category to produce notification text having a formality level and a politeness level corresponding to the dominant emotion category.

10. The system according to claim 9, wherein the emotion estimation neural network classifier receives word embeddings derived from the input information and outputs the probability distribution via a softmax output layer.

11. The system according to claim 1, wherein the circuitry is further configured to:
generate a second natural-language prompt sentence incorporating the format classification and the structured attribute information and supply the second natural-language prompt sentence to the transformer-based generative neural network model to acquire notification text comprising a subject line, a body message, and a participant address list.

12. The system according to claim 11, wherein the circuitry is further configured to:
convert the notification text into a standardized message format comprising header fields and a body field conforming to an electronic messaging protocol; and
transmit the standardized message to the schedule management server via the communication interface for registration as a calendar entry.

13. The system according to claim 12, wherein the circuitry is further configured to:
receive, from the terminal device, editing information indicating user modifications to the notification text; and
generate a regeneration prompt sentence incorporating the editing information and supply the regeneration prompt sentence to the transformer-based generative neural network model to acquire refined notification text.

14. The system according to claim 13, wherein the circuitry is further configured to:
store, in the non-transitory storage medium, a version history comprising a first version of the structured notification data and a second version incorporating the user modifications.

15. The system according to claim 14, wherein the input information comprises a natural language instruction from a user requesting creation of a meeting notification, and wherein the structured notification data comprises a meeting invitation including a meeting subject, a meeting date and time, a list of invitees, a meeting location or access link, and an agenda summary.

16. The system according to claim 15, wherein the rule set encodes pattern rules for detecting terms associated with online meetings including conferencing service names and terms associated with in-person meetings including location-specific terms, and wherein each pattern rule has an associated priority weight used in computing the confidence scores.

17. The system according to claim 16, wherein the schedule management server is a calendar service accessible via an application programming interface, and wherein registering the structured notification data comprises transmitting to the calendar service, via the communication interface, a calendar event object comprising the meeting subject, the meeting date and time, the list of invitees, and the meeting location or access link.

18. A system comprising:
circuitry configured to:
receive, via a communication interface coupled to a packet-switched network conforming to at least one of a 5G, Wi-Fi, or Bluetooth communication standard, input information from a terminal device comprising a display, an input device, and a communication module;
normalize the input information into an internal data record comprising a user identifier, a prompt text, and a request timestamp;
construct a natural-language prompt sentence by concatenating an instruction template with the prompt text and converting the concatenated text into a token sequence using a tokenizer;
supply the token sequence to a transformer-based generative neural network model comprising a stack of self-attention layers and feed-forward layers and acquire an analysis result comprising structured attribute information;
apply natural language processing including part-of-speech tagging and named entity recognition to the input information and scan annotated tokens against a rule set to extract candidate format indicators with confidence scores;
combine the candidate format indicators with the analysis result using a decision algorithm to determine a format classification;
apply an emotion estimation neural network classifier to data received from the terminal device to compute a dominant emotion category;
generate structured notification data based on the format classification, the structured attribute information, and the dominant emotion category, the structured notification data comprising a notification subject, a body message with a tone adjusted according to the dominant emotion category, and format-specific access information; and
transmit the structured notification data, via the communication interface coupled to the packet-switched network, to a schedule management server for registration as a calendar entry and to the terminal device for rendering on the display.

19. The system according to claim 18, wherein the circuitry is further configured to:
receive editing information from the terminal device indicating user modifications, generate a regeneration prompt sentence incorporating the editing information, supply the regeneration prompt sentence to the transformer-based generative neural network model, and acquire refined structured notification data.

20. A method comprising:
receiving, by circuitry via a communication interface coupled to a packet-switched network, input information from a terminal device;
constructing, by the circuitry, a natural-language prompt sentence based on the input information and supplying the natural-language prompt sentence to a transformer-based generative neural network model to acquire an analysis result;
evaluating, by the circuitry, the analysis result against a rule set stored in a non-transitory storage medium to determine a format classification; and
generating, by the circuitry, based on the format classification and the analysis result, structured notification data and transmitting the structured notification data, via the communication interface coupled to the packet-switched network, to a schedule management server for registration and to the terminal device for rendering on a display.
